(19) United States
(12) Patent Application Publication
(10) Pub. No.: US 2009/0067292 A1
(43) Pub. Date: Mar. 12, 2009

(54) ACOUSTIC SIGNAL TRANSMISSION SYSTEM, MODULATION DEVICE, DEMODULATION DEVICE, AND ACOUSTIC SIGNAL TRANSMISSION METHOD

(75) Inventor: Hosei Matsuoka, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NTT DoCoMo, Inc., Chiyoda-ku (JP)

(21) Appl. No.: 12/280,172

(22) PCT Filed: Jan. 26, 2007
(86) PCT No.: PCT/JP2007/051278

§ 371 Date: Aug. 21, 2008

(30) Foreign Application Priority Data
Feb. 22, 2006 (JP) 2006-045591

(51) Int. Cl. H04B 1/02

(52) U.S. Cl. 367/137

(57) ABSTRACT

An acoustic signal transmission system of the present invention is a system for transmitting information via sound waves, and has a modulation device, a plurality of speakers, a microphone and a demodulation device. The modulation device generates transmission acoustic signals by encoding transmission signals based on a transmission diversity method and allocating the encoded transmission signals to a plurality of transmission paths. The plurality of speakers output the transmission acoustic signals as sound waves respectively based on the allocation. The microphone receives the sound waves which are output from the plurality of speakers, and outputs received acoustic signals. The demodulation device decodes the received acoustic signals based on the transmission diversity method by using a transfer function of the each sound wave from the plurality of speakers to the microphone.

### TECHNICAL FIELD

A present invention relates to an acoustic signal transmission system, a modulation device, a demodulation device and an acoustic signal transmission method.

### BACKGROUND ART

As a communication technology to transmit information via acoustic waves, a method of using ultrasonic waves and a method of using audible sound waves are known. An advantage of using ultrasonic waves is that individuals experience no uncomfortable influence during transmission, since ultrasonic waves cannot be recognized by the human auditory sense. Also ultrasonic waves can be applied to small area communication because of its sharp directivity.

An advantage of using audible sound waves is that commercial audio equipment can be used as a communication device. Many commercial audio equipment can record and reproduce audible sound waves, but cannot handle ultrasonic waves. Also sound waves are absorbed and attenuated due to the viscosity of the medium. This absorption and attenuation increases in proportion to the frequency. This means that the attenuation, with respect to distance, is smaller in audible sound waves than in ultrasonic waves, and communication distance can be increased by using the audible sound waves.

An example of the technology for performing communication using audible sound waves is a method of transmitting transmission signals by spreading the spectrum based on the frequency masking threshold of voice or music (see Patent Document 1).

“Patent Document 1” is International Publication WO02/45286 pamphlet.

### DISCLOSURE OF THE INVENTION

### Problem to be Solved by the Invention

However, if transmission signals generated by the technology disclosed in Patent Document 1 is input to audio equipment for stereo reproduction or for surround-sound reproduction, the same transmission signals are output from a plurality of speakers. The transmission signals which are output from the plurality of speakers mutually interfere, and frequency-selected fading is generated. As a result, reception errors will occur more frequently.

With the foregoing in view, it is an object of the present invention to provide an acoustic signal transmission system, a modulation device, a demodulation device and an acoustic signal transmission method where the occurrence of reception errors is suppressed.

### Means for Solving the Problem

An acoustic signal transmission system of the present invention is a system for transmitting information via sound waves, comprising: a modulation device that generates a plurality of transmission acoustic signals by encoding transmission signals based on a transmission diversity method and allocating the encoded transmission signals to a plurality of transmission paths; a plurality of speakers that output the plurality of transmission acoustic signals as sound waves respectively based on the allocation; a microphone that receives the sound waves which are output from the plurality of speakers and outputs received acoustic signals; and a demodulation device that decodes the received acoustic signals based on the transmission diversity method by using a transfer function of the each sound wave from each of the plurality of speakers to the microphone.

An acoustic signal transmission method of the present invention is a method for transmitting information via sound waves, comprising: a modulation step wherein a modulation device generates a plurality of transmission acoustic signals, by encoding transmission signals based on a transmission diversity method and allocating the encoded transmission signals to a plurality of transmission paths; an output step wherein a plurality of speakers output said plurality of transmission acoustic signals as sound waves respectively based on said allocation; a reception step wherein a microphone receives the sound waves which are output from said plurality of speakers and outputs received acoustic signals; and a demodulation step wherein a demodulation device decodes the received acoustic signals based on the transmission diversity method by using a transfer function of the each sound wave from each of said plurality of speakers to said microphone.

According to the present invention, the modulation device allocates the transmission acoustic signals to the transmission paths, the plurality of speakers outputs the allocated transmission acoustic signals respectively as sound waves, and the demodulation device decodes the sound waves by using the transfer function of each sound wave from each of the plurality of speakers to the microphone. Therefore, even if frequency-selected fading is generated, transmission signals can be decoded with suppressing the occurrence of reception errors by using each of the transfer functions. Also according to the present invention, the modulation device encodes the transmission signals based on the transmission diversity method, and allocates the encoded transmission signals to the plurality of transmission paths, and the demodulation device decodes the transmission signals based on the transmission diversity method. Therefore the spread of space and frequency delays can be effectively handled. In other words, reception errors can be effectively suppressed.

A modulation device of the present invention comprises: encoding means for generating a plurality of encoded transmission signals by encoding transmission signals based on spatial frequency encoding and allocating the encoded transmission signals to a plurality of transmission paths; and modulation means for generating a plurality of transmission acoustic signals by modulating sub-carriers in an audible sound band based on OFDM by using the allocated encoded transmission signals respectively, and allocating the modulated sub-carriers to the plurality of transmission paths.

A demodulation device of the present invention comprises: demodulation means for generating encoded received signals by demodulating received acoustic signals, which are output from a plurality of speakers and received by a microphone, based on OFDM; and decoding means for decoding the encoded received signals based on spatial frequency decoding, by using a transfer function of the each sound wave from each of the plurality of speakers to the microphone.

According to the present invention, the modulation device generates the encoded transmission signals by allocating the transmission signals to the plurality of transmission paths, and the demodulation device decodes the encoded received signals based on the spatial frequency decoding by using the transfer function of the each sound wave from each of the plurality of speakers to the microphone. Therefore, even if frequency-selective fading is generated, transmission signals can be decoded with suppressing the occurrence of reception errors by using each of the transfer functions. Also according to the present invention, the modulation device encodes the transmission signals based on the spatial frequency encoding and allocates the transmission signals to the plurality of transmission paths, and the demodulation device decodes the transmission signals based on the spatial frequency decoding. Therefore, the spread of spatial and frequency delays can be handled more effectively. In other words, reception errors can be effectively suppressed.

An acoustic signal transmission system of the present invention is a system for transmitting information via sound waves, comprising: a modulation device that generates a plurality of transmission acoustic signals by allocating transmission signals to a plurality of transmission paths; a plurality of speakers that output the plurality of transmission acoustic signals as sound waves respectively based on the allocation; a plurality of microphones that receive the sound waves which are output from the plurality of speakers and output received acoustic signals respectively; and a demodulation device that decodes the received acoustic signals by using a transfer function of the each sound wave from each of the plurality of speakers to each of the plurality of microphones.

An acoustic signal transmission method of the present invention is a method for transmitting information via sound waves, comprising: a modulation step wherein a modulation device generates a plurality of transmission acoustic signals by allocating transmission signals to a plurality of transmission paths; an output step wherein a plurality of speakers output said plurality of transmission acoustic signals as sound waves respectively based on said allocation; a reception step wherein a plurality of microphones receive the sound waves which are output from said plurality of speakers, and output received acoustic signals respectively; and a demodulation step wherein a demodulation device decodes said received acoustic signals by using a transfer function of the each sound wave from each of said plurality of speakers to each of said plurality of microphones.

According to the present invention, the modulation device allocates the transmission signals to the plurality of transmission paths, and the plurality of speakers output the allocated transmission acoustic signals respectively as sound waves. Then the plurality of microphones receive the sound waves which are output, and the demodulation device decodes the sound waves by using the transfer function of the each sound wave from each of the plurality of speakers to each of the plurality of microphones. Therefore, even if frequency-selected fading is generated, transmission signals can be decoded with suppressing the occurrence of reception errors by using each of the transfer functions. Also sound waves are received by the plurality of microphones, so the occurrence of reception errors can be more effectively suppressed.

It is preferable that the modulation device of the acoustic signal transmission system comprises allocation means for allocating the transmission signals to the frequency of each sub-carrier which is transmitted by each of the plurality of transmission paths respectively, based on directional characteristics of the sub-carrier. Thereby transmission signals can be transmitted corresponding to the directional characteristics which differ depending on the frequency of the sub-carrier.

It is preferable that the modulation device of the present invention comprises allocation means for allocating the transmission paths, and modulation means for generating a plurality of transmission acoustic signals by modulating sub-carriers in an audible sound band based on OFDM by using the transmission signals that are encoded, and allocating the modulated sub-carriers to the plurality of transmission paths.

A demodulation device of the present invention comprises: demodulation means for generating encoded received signals by respectively demodulating received acoustic signals, which are output from a plurality of speakers and received respectively by a plurality of microphones, based on OFDM; and decoding means for decoding the encoded received signals by using a transfer function of the each sound wave from each of the plurality of speakers to each of the plurality of microphones.

According to the present invention, in the modulation device, the allocation means allocates the transmission signals to the plurality of transmission paths, and decoding means decodes the received acoustic signals by using the transfer function of the each sound wave from each of the plurality of speakers to each of the plurality of microphones. Therefore even if frequency-selected fading is generated, transmission signals can be decoded with suppressing the occurrence of reception errors by using each of the transfer functions. Also transmission signals are decoded by using the received acoustic signals received by the plurality of microphones, so the occurrence of reception errors can be more effectively suppressed.

It is also preferable that the plurality of transmission paths of the modulation device include a first transmission path and a second transmission path, and the allocation means allocates transmission signals to sub-carriers having a relatively low frequency, out of the sub-carriers that are output by the first transmission path, and allocates the allocated transmission signals to sub-carriers having a relatively high frequency, out of the sub-carriers that are output by the second transmission path.

Thereby transmission signals allocated to a sub-carrier having a high frequency with sharp directivity, which is output by the second transmission path, can be allocated to a sub-carrier having low frequency with wide directivity, which is output by the first transmission path. Therefore even if the sound wave, including transmission signals, is weak because the high frequency sub-carrier is output while deviating from the center of the speaker, a low frequency sub-carrier can be output as a strong sound wave. Hence the transmission signals can be sent with better certainty, and the occurrence of reception errors can be suppressed.

### EFFECT OF THE INVENTION

According to the present invention, an acoustic signal transmission system, a modulation device, a demodulation device and an acoustic signal transmission method, where the occurrence of reception errors is suppressed, can be provided.

### BRIEF DESCRIPTION OF THE DRAWINGS

FIG. 1 is a block diagram depicting an acoustic signal sending system included in an acoustic signal transmission system according to a first embodiment.

FIG. 2 is a block diagram depicting an acoustic signal receiving system included in an acoustic signal transmission system according to the first embodiment.

FIG. 3 is a diagram depicting a configuration of a modulation device according to the first embodiment.

FIG. 4 is a diagram depicting L signal and R signal according to the first embodiment.

FIG. 5 is a diagram depicting a configuration of a demodulation device according to the first embodiment.

FIG. 6 is a flow chart depicting an operation of the acoustic signal sending system according to the first embodiment.

FIG. 7 is a flow chart depicting an operation of the acoustic signal receiving system according to the first embodiment.

FIG. 8 is a block diagram depicting an acoustic signal sending system included in an acoustic signal transmission system according to a second embodiment.

FIG. 9 is a block diagram depicting an acoustic signal receiving system included in an acoustic signal transmission system according to the second embodiment.

FIG. 10 is a diagram depicting a configuration of a modulation device according to the second embodiment.

FIG. 11 is a diagram depicting L signal and R signal according to the second embodiment.

FIG. 12 is a diagram depicting a configuration of a demodulation device according to the second embodiment.

FIG. 13 is a flow chart depicting an operation of the acoustic signal sending system according to the second embodiment.

FIG. 14 is a flow chart depicting an operation of the acoustic signal receiving system according to the second embodiment.

FIG. 15 is a diagram depicting a configuration of a modulation device according to a third embodiment.

FIG. 16 is a diagram depicting L signal and R signal according to the third embodiment.

FIG. 17 is a diagram depicting a configuration of a demodulation device according to the third embodiment.

### DESCRIPTION OF REFERENCE SYMBOLS

TS1, TS2 are for acoustic signal sending system; RS1, RS2 are for acoustic signal receiving system; 4A-4C are for demodulation device; 6L, 6R are for speaker; 7 is for sound wave; 8, 8L, 8R are for microphone; 10A-10C are for demodulation device; 12 is for error correction decoding device; 41A-41C are for S/P conversion unit; 43L, 43R are for modulation unit; 46 is for guard time signal generation unit; 47 is for frame synchronization signal generation unit; 48 is for D/A conversion unit; 101 is for A/D conversion unit; 102 is for frame synchronization unit; 103 is for guard time removal unit; 104L, 104R are for demodulation unit; 106 is for SFBC decoding unit; 107 is for P/S conversion unit; 109B, 109C are for MIMO decoding unit.

### BEST MODE FOR CARRYING OUT THE INVENTION

Best modes for carrying out the invention will now be described with reference to the accompanying drawings. In the description of the drawings, the same composing elements are denoted with the same reference symbols, for which redundant description will be omitted.

### FIRST EMBODIMENT

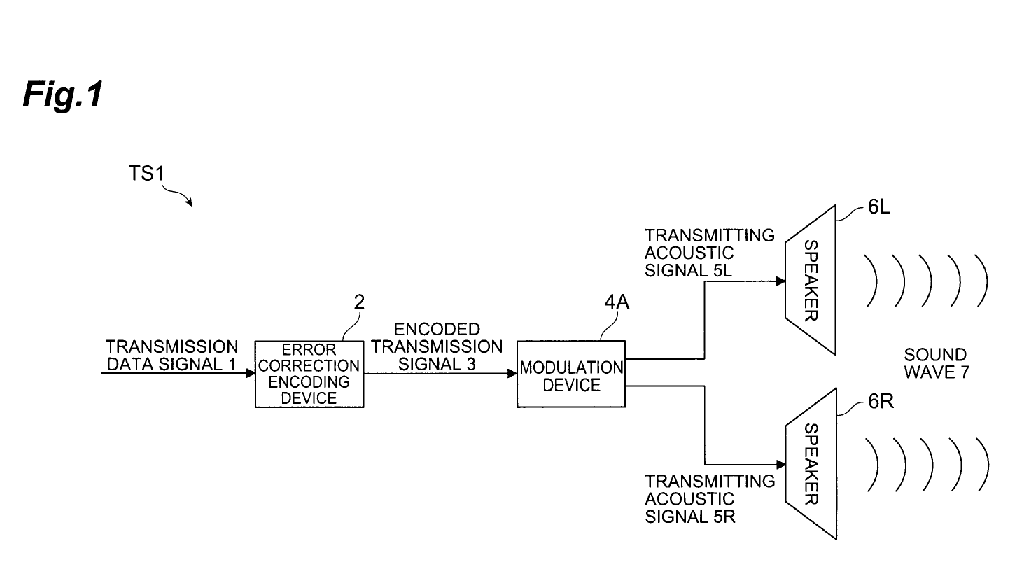

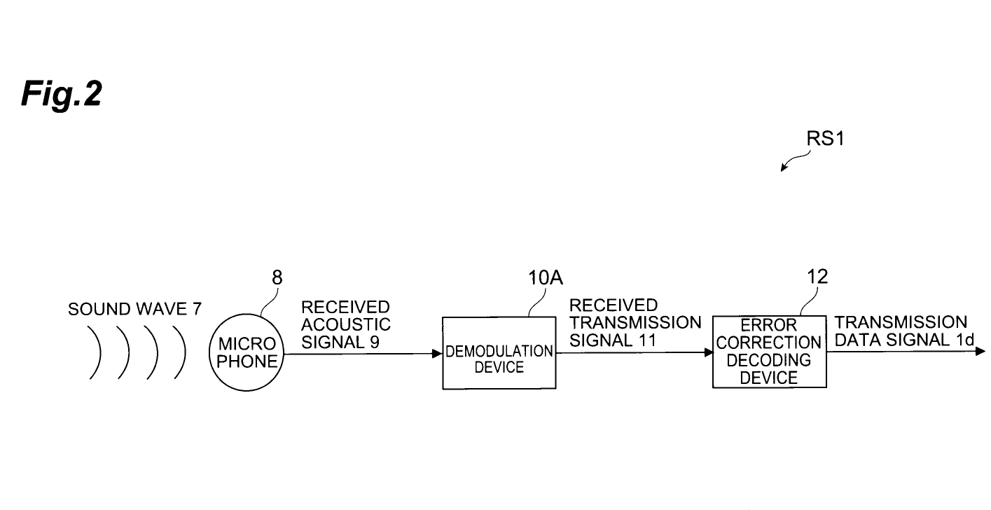

FIG. 1 is a block diagram depicting an acoustic signal sending system included in an acoustic signal transmission system according to a first embodiment. FIG. 2 is a block diagram depicting an acoustic signal receiving system included in the acoustic signal transmission system according to the first embodiment. The acoustic signal transmission system according to the present embodiment includes the acoustic signal sending system TS1 and the acoustic signal receiving system RS1.

The acoustic signal sending system TS1 is a system that generates transmission acoustic signals 5L and 5R and outputs them as sound waves 7. The acoustic signal sending system TS1 includes an error correction encoding device 2, a modulation device 4A and a plurality of speakers (two speakers in the case of the present embodiment) 6L and 6R.

The error correction encoding device 2 encodes transmission data signals 1 using error correction codes, and outputs encoded transmission signals 3. The modulation device 4A generates the transmission acoustic signals by allocating the encoded transmission signals 3 to the speaker 6L and the speaker 6R and modulating the encoded transmission signals 3. In other words, the modulation device 4A generates the transmission acoustic signal 5L, allocated to the speaker 6L, and the transmission acoustic signal 5R, allocated to the speaker 6R respectively, and outputs them. The speaker 6L outputs the transmission acoustic signal 5L as a sound wave 7. The speaker 6R outputs the transmission acoustic signal 5R as a sound wave 7. The speaker 6L and the speaker 6R constitute a stereo speaker.

The acoustic signal receiving system RS1 is a system that receives the sound wave 7 which is output by the acoustic signal sending system TS1, and extracts a transmission data signal 1d. The acoustic signal receiving system RS1 includes one microphone 8, demodulation device 10A and error correction decoding device 12.

The microphone 8 receives the sound wave 7, and outputs the received acoustic signal 9. The demodulation device 10A demodulates the received acoustic signal 9, and generates and outputs a receive transmission signal 11. The error correction decoding device 12 corrects an error of the receive transmission signal 11, and outputs it as a transmission data signal 1d.

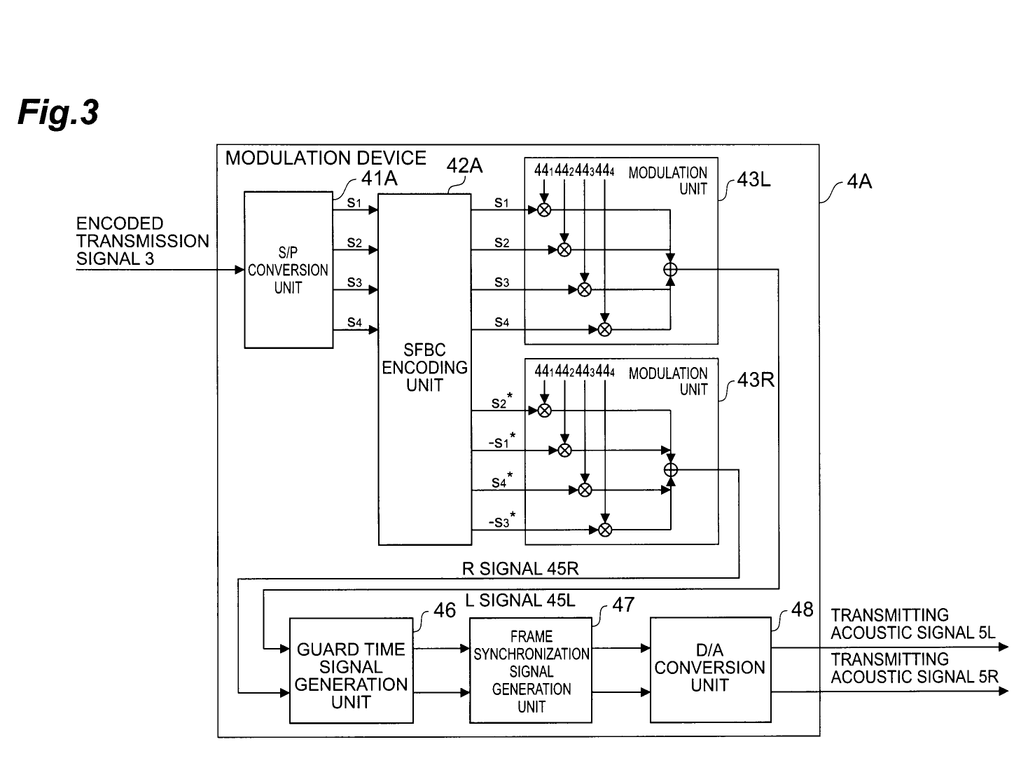

The modulation device 4A and the demodulation device 10A will now be described in detail. FIG. 3 is a diagram depicting a configuration of the modulation device according to the first embodiment. The modulation device 4A includes an S/P conversion unit 41A, an SFBC encoding unit (encoding means) 42A, a modulation unit (modulation means) 43L, a modulation unit 43R, a guard time signal generation unit 46, a frame synchronization signal generation unit 47 and a D/A conversion unit 48.

The S/P conversion unit 41A converts an encoded transmission signal 3 from a single bit stream into a parallel bit stream, and extracts parallel transmission bits s₁, s₂, s₃ and s₄. The S/P conversion unit 41A outputs the parallel transmission bits s₁, s₂, s₃ and s₄ to the SFBC encoding unit 42A.

The SFBC encoding unit 42A generates transmission signals by encoding the parallel transmission bits s₁, s₂, s₃ and s₄ based on the transmission diversity method and allocating the encoded bits to a plurality of transmission paths. Specifically, the SFBC encoding unit 42A encodes the parallel transmission bits s₁, s₂, s₃ and s₄ based on spatial frequency encoding, and allocates the two sets of parallel transmission bits (s₁, s₂, s₃, s₄) (s₂*, −s₁*, s₄*, −s₃) to the speaker 6L and the speaker 6R, and outputs these bits.

In the spatial frequency encoding, a plurality of speakers and a plurality of sub-carriers are regarded as one block of encoding. The SFBC encoding unit 42A regards the speaker 6L and speaker 6R and the two sub-carriers of which frequencies are adjacent are regarded as one block of spatial frequency encoding.

In other words, the SFBC encoding unit 42A allocates the parallel transmission bit s₁ to the first sub-carrier 44₁ which is output from the speaker 6L, and allocates the parallel transmission bit s₂ to the second sub-carrier 44₂ which is output from the speaker 6L. The SFBC encoding unit 42A also allocates the parallel transmission bit s₂* to the first sub-carrier 44₁ which is output from the speaker 6R, and allocates the parallel transmission bit −s₁* to the second sub-carrier 44₂ which is output from the speaker 6R.

In the same manner, the SFBC encoding unit 42A allocates the parallel transmission bit s₃ to the third sub-carrier 44₃ which is output from the speaker 6L, and allocates the parallel transmission bit s₄ to the fourth sub-carrier 44₄ which is output from the speaker 6L. The SFBC encoding unit 42A also allocates the parallel transmission bit s₄* to the third sub-carrier 44₃ which is output from the speaker 6R, and allocates the parallel transmission bit −s₃* to the fourth sub-carrier 44₄ which is output from the speaker 6R.

In the first to fourth sub-carriers 44₁ to 44₄, the frequency is lower in the sequence of the first sub-carrier 44₁, second sub-carrier 44₂, third sub-carrier 44₃ and fourth sub-carrier 44₄. The parallel transmission bits s₁, s₂, s₃ and s₄ are signals which are allocated to the speaker 6L, and the parallel transmission bits s₂*, −s₁*, s₄* and −s₃* are signals which are allocated to the speaker 6R. The SFBC encoding unit 42A allocates the parallel transmission bits s₁, s₂, s₃ and s₄ to the first to fourth sub-carriers 44₁ to 44₄ respectively, and outputs them to the modulation unit 43L, and allocates the parallel transmission bits s₂*, −s₁*, s₄* and −s₃* to the first to fourth sub-carriers 44₁ to 44₄ respectively, and outputs them to the modulation unit 43R.

The modulation unit 43L modulates the first to fourth sub-carriers 44₁ to 44₄ with the corresponding parallel transmission bits s₁, s₂, s₃ and s₄ respectively, based on OFDM (Orthogonal Frequency Division Multiplex). The modulation unit 43L outputs a signal generated by the modulation, to the guard time signal generation unit 46 as L signal 45L.

The modulation unit 43R modulates the first to fourth sub-carriers 44₁ to 44₄ with the corresponding parallel transmission bits s₂*, −s₁*, s₄* and −s₃* respectively, based on OFDM. The modulation unit 43R outputs a signal, which is generated by the modulation, to the guard time signal generation unit 46 as R signal 45R.

The guard time signal generation unit 46 copies the back block of the signal, and generates a guard time signal respectively for the L signal 45L and the R signal 45R. The guard time signal generation unit 46 links the generated guard time signals to the front of the L signal 45L and the R signal 45R respectively. Thereby multi-path interference, such as reflected waves, during transmitting a transmission signal can be handled. The guard time signal generation unit 46 outputs the L signal 45L and the R signal 45R, to which the guard time signal has been added, to the frame synchronization signal generation unit 47.

The frame synchronization signal generation unit 47 generates a frame synchronization signal, and adds the frame synchronization signal to both the L signal 45L and the R signal 45R. The frame synchronization signal is a signal for the receiving side to specify the location of the guard time signal included in the L signal 45L and the R signal 45R respectively. Specifically, the frame synchronization signal is a PN (Pseudo Noise) signal modulated with M series codes. The frame synchronization signal generation unit 47 also adds a pilot signal to both the L signal 45L and the R signal 45R, in order to distinguish the L signal 45L from the R signal 45R. The frame synchronization signal generation unit 47 outputs the L signal 45L and the R signal 45R, to which the frame synchronization signal has been added, to the D/A conversion unit 48.

The D/A conversion unit 48 generates a transmission acoustic signal 5L by converting the L signal 45L into analog, and generates a transmission acoustic signal 5R by converting the R signal 45R into analog. The D/A conversion unit 48 then outputs the generated transmission acoustic signal 5L to the speaker 6L, and outputs the transmission acoustic signal 5R to the speaker 6R.

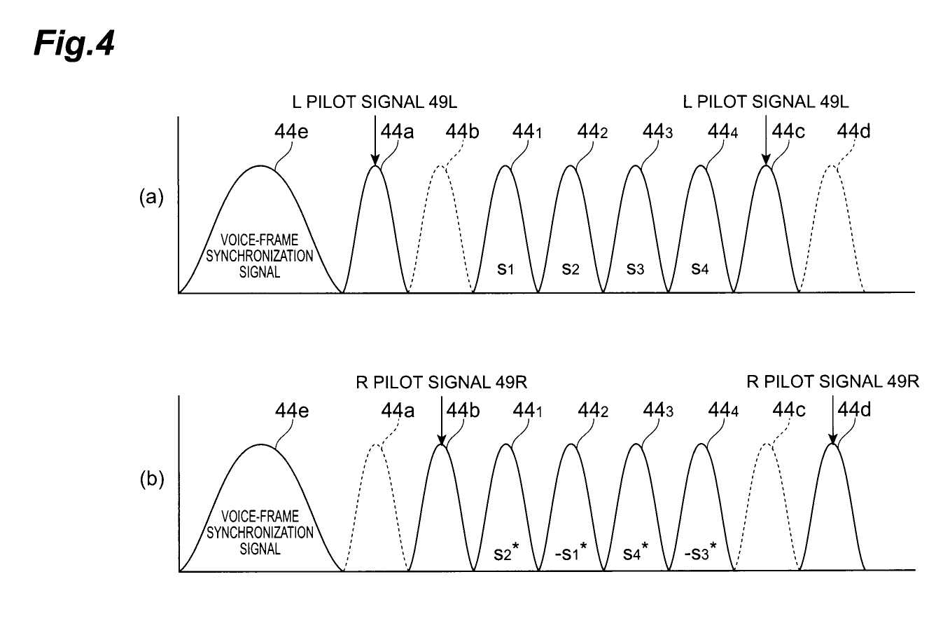

FIG. 4 are diagrams depicting the transmission acoustic signal according to the first embodiment. (a) of FIG. 4 is a diagram depicting the transmission acoustic signal 5L. (b) of FIG. 4 is a diagram depicting the transmission acoustic signal 5R.

As (a) of FIG. 4 shows, the parallel transmission bit s₁ is allocated to the first sub-carrier 44₁, the parallel transmission bit s₂ is allocated to the second sub-carrier 44₂, the parallel transmission bit s₃ is allocated to the third sub-carrier 44₃, and the parallel transmission bit s₄ is allocated to the fourth sub-carrier 44₄ of the transmission acoustic signal 5L.

In the transmission acoustic signal 5L, an L pilot signal for 49L, which indicates that this signal is the transmission acoustic signal 5L, is allocated to sub-carriers 44a and 44c having a frequency different from the first to fourth sub-carriers 44₁ to 44₄. In the transmission acoustic signal 5L, sub-carriers 44b and 44d, having a frequency different from the first to fourth sub-carriers 44₁ to 44₄ and sub-carriers 44a and 44c, are not used. In the transmission acoustic signal 5L, voice and a frame synchronization signal are disposed in a frequency band which is different from the first to fourth sub-carriers 44₁ to 44₄ and 44a to 44d.

As (b) of FIG. 4 shows, the parallel transmission bit s₂* is allocated to the first sub-carrier 44₁, the parallel transmission bit −s₁* is allocated to the second sub-carrier 44₂, the parallel transmission bit s₄* is allocated to the third sub-carrier 44₃, and the parallel transmission bit −s₃* is allocated to the fourth sub-carrier 44₄ of the transmission acoustic signal 5R.

In the transmission acoustic signal 5R, an R pilot signal for 49R, which indicates that this signal is the transmission acoustic signal 5R, is allocated to the sub-carriers 44b and 44d. In the transmission acoustic signal 5L, the sub-carriers 44a and 44c are not used. In the transmission acoustic signal 5R, voice and a frame synchronization signal are disposed in a frequency band which is different from the first to fourth sub-carriers 44₁ to 44₄ and 44a to 44d.

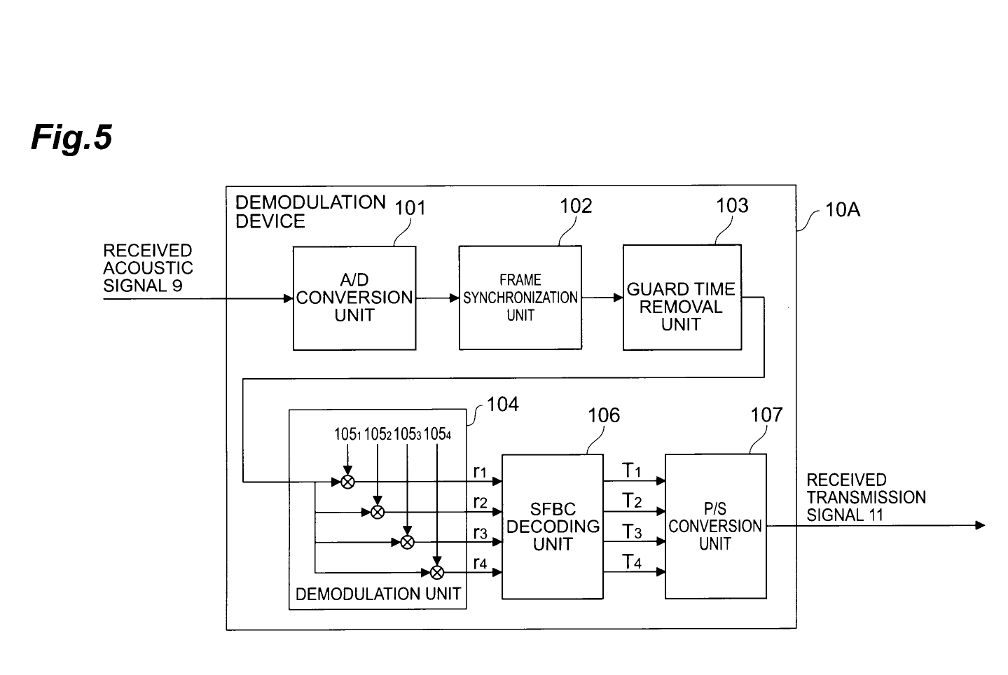

FIG. 5 is a diagram depicting a configuration of the demodulation device according to the first embodiment. The demodulation device 10A according to the present embodiment includes an A/D conversion unit 101, a frame synchronization unit 102, a guard signal removal unit 103, a demodulation unit (demodulation means) 104, an SFBC decoding unit (decoding means) 106 and a P/S conversion unit 107.

The A/D conversion unit 101 samples a received acoustic signal 9, which is output from the microphone 8, and converts it into a digital signal. The A/D conversion unit 101 outputs the digital signal to the frame synchronization unit 102.

The frame synchronization unit 102 divides the input digital signal into frame units. More specifically, the frame synchronization unit 102 correlates the input digital signal with a PN signal, which is modulated with M series codes, while shifting one sample or several samples at a time, and recognizes a point at which the correlation value is highest as a frame synchronization point, and divides the digital signal into frame units based on this frame synchronization point. The frame synchronization unit 102 outputs the digital signal to the guard time removal unit 103 for each divided frame.

The guard time removal unit 103 removes a guard time signal from the digital signals for each divided frame so as to extract the signal frame. The guard time removal unit 103 outputs the extracted signal frame to the demodulation unit 104.

The demodulation unit 104 demodulates the signal frame by the first to fourth sub-carriers 105₁ to 105₄ based on OFDM, and extracts the parallel received bits r₁, r₂, r₃ and r₄. In the first to fourth sub-carriers 105₁ to 105₄, the frequency is lower in the sequence of the first sub-carrier 105₁, second sub-carrier 105₂, third sub-carrier 105₃ and fourth sub-carrier 105₄. The demodulation unit 104 extracts the parallel received bit r₁ by the first sub-carrier 105₁, extracts the parallel received bit r₂ by the second sub-carrier 105₂, extracts the parallel received bit r₃ by the third sub-carrier 105₃, and extracts the parallel received bit r₄ by the fourth sub-carrier 105₄.

The demodulation unit 104 also demodulates the sub-carrier of the pilot signal included in the signal frame based on OFDM, and extracts an L pilot signal or an R pilot signal. Thereby it can be identified whether the parallel received bit r₁, r₂, r₃ or r₄ of each signal frame is a signal output from the speaker 6L or a signal output from the speaker 6R. The demodulation unit 104 outputs the parallel received bits r₁, r₂, r₃ and r₄ extracted from the signal frame including the L pilot signal, and the parallel received bits r₁, r₂, r₃ and r₄ extracted from the signal frame including the R pilot signal, to the SFBC decoding unit 106 such that identification is possible.

The SFBC decoding unit 106 decodes the signal frames based on the transmission diversity method using a transfer function when the sound wave is transmitted from each speaker 6L and 6R to the microphone 8. In other words, the SFBC decoding unit 106 extracts parallel transmission bits T₁, T₂, T₃ and T₄ by decoding the parallel received bits r₁, r₂, r₃ and r₄ based on SFBC (Space-Frequency Block Coding) using the transfer function from the speaker 6L to the microphone 8 and the transfer function from the speaker 6R to the microphone 8.

The SFBC decoding unit 106 calculates the transfer function h_{L12} from the speaker 6L to the microphone 8 using the first and second sub-carriers 105₁ and 105₂ of the parallel received bit pair (r₁, r₂) extracted from the signal frame that includes the L pilot signal. The SFBC decoding unit 106 also calculates the transfer function h_{L34} from the speaker 6L to the microphone 8 using the third and fourth sub-carriers 105₃ and 105₄ of the parallel received bit pair (r₃, r₄) extracted from the signal frame that includes the L pilot signal.

The SFBC decoding unit 106 calculates the transfer function h_{R12} from the speaker 6R to the microphone 8 using the first and second sub-carriers 105₁ and 105₂ of the parallel received bit pair (r₁, r₂) extracted from the signal frame that includes the R pilot signal. The SFBC decoding unit 106 also calculates the transfer function h_{R34} from the speaker 6R to the microphone 8 using the third and fourth sub-carriers 105₃ and 105₄ of the parallel received bit pair (r₃, r₄) extracted from the signal frame that includes the R pilot signal.

Using the calculated transfer functions h_{L12}, h_{L34}, h_{R12} and h_{R34}, the SFBC decoding unit 106 calculate the parallel transmission bits T₁, T₂, T₃ and T₄ as the following Formulas (1).

### [Formulas 1]

$$\begin{matrix}{T}_{1} = {h}_{L 12}^{*} {r}_{1} - {h}_{R 12} {r}_{2}^{*} \\ {T}_{2} = {h}_{L 12}^{*} {r}_{2} + {h}_{R 12} {r}_{1}^{*} \\ {T}_{3} = {h}_{L 34}^{*} {r}_{3} - {h}_{R 34} {r}_{4}^{*} \\ {T}_{4} = {h}_{L 34}^{*} r + {h}_{R 34} {r}_{3}^{*}\end{matrix} \} \qquad ( 1 )$$

The SFBC decoding unit 106 outputs the calculated parallel transmission bits T₁, T₂, T₃ and T₄ to the P/S conversion unit 107.

The P/S conversion unit 107 converts the parallel transmission bits T₁, T₂, T₃ and T₄ into a single transmission bit stream, and outputs it as a receive transmission signal 11.

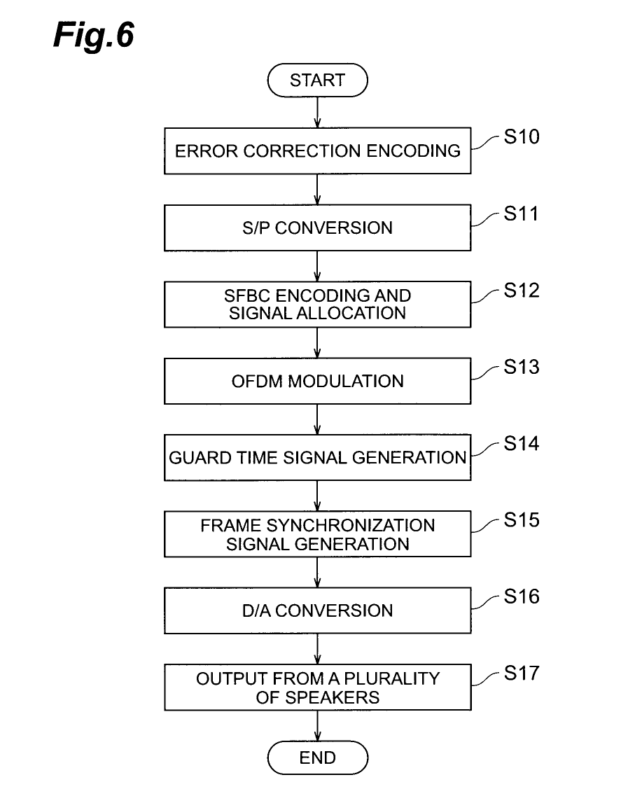

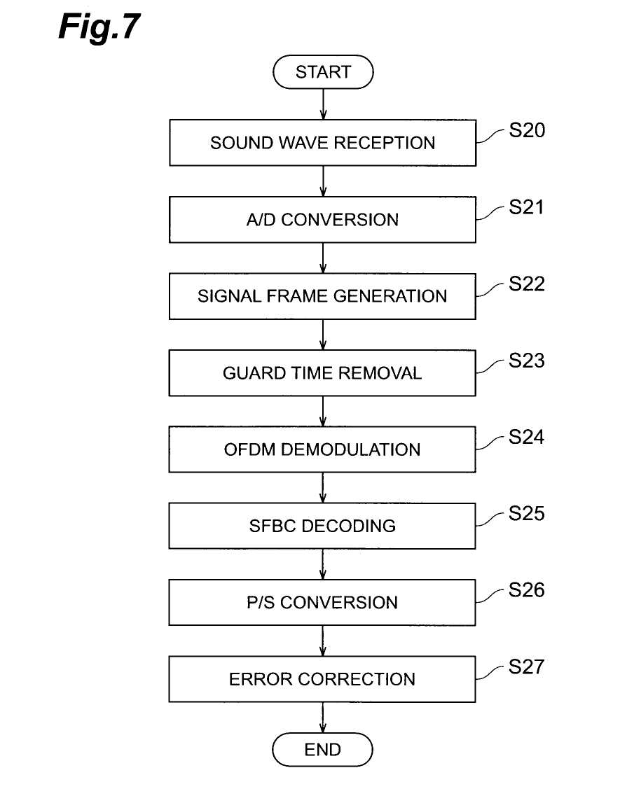

Now the operation of the acoustic signal sending system TS1 including the demodulation device 4A and the operation of the acoustic signal receiving system RS1 including the modulation device 10A will be described, and the acoustic signal transmission method according to the present embodiment will be described with reference to FIG. 6 and FIG. 7. FIG. 6 is a flow chart depicting the operation of the acoustic signal sending system according to the first embodiment, and FIG. 7 is a flow chart depicting the operation of the acoustic signal receiving system according to the first embodiment.

First the operation of the acoustic signal sending system TS1 will be described with reference to FIG. 6. The transmission data signal 1 is encoded by the error correction encoding device 2 using error correction codes, and the encoded transmission signal 3 is generated (S10). The generated encoded transmission signal 3 is converted into a parallel bit stream by the S/P conversion unit 41A of the modulation device 4A (S11).

The parallel transmission bits s₁, s₂, s₃ and s₄ of the parallel bit stream are encoded by the SFBC encoding unit 42A of the modulation device 4A based on the spatial frequency encoding, and each of the two sets of parallel transmission bits (s₁, s₂, s₃, s₄) and (s₂*, −s₁*, s₄*, −s₃*) are allocated to the speaker 6L and the speaker 6R respectively (S12). For each of the two sets of parallel bits (s₁, s₂, s₃, s₄) and (s₂*, −s₁*, s₄*, −s₃*), the sub-carriers 44 are modulated by the modulation units 43L and 43R based on OFDM, and the L signal 45L and the R signal 45R are generated respectively (S13). In other words, in step S12 and step S13, the transmission signals are encoded based on the transmission diversity method, and are allocated to a plurality of transmission paths (modulation step).

When the L signal 45L and the R signal 45R are generated, the guard time signal is generated by the guard time signal generation unit 46, and is added to the L signal 45L and the R signal 45R respectively (S14). When the guard time signal is added, the frame synchronization signal is generated by the frame synchronization signal generation unit 47, and is added to the L signal 45L and the R signal 45R respectively (S15). The L signal 45L and the R signal 45R, to which the frame synchronization signal is added, are converted into analog signals respectively by the D/A conversion unit 48, and the transmission acoustic signal 5L and the transmission acoustic signal 5R are generated (S16).

When the transmission acoustic signal 5L and the transmission acoustic signal 5R are generated, the transmission acoustic signal 5L and the transmission acoustic signal 5R are output from the speaker 6L and the speaker 6R respectively as sound waves 7 (S17) (output step). In this way, the sound wave 7 carrying the transmission data signal 1 is output from the two speakers 6L and 6R.

Now the operation of the acoustic signal receiving system RS1 will be described with reference to FIG. 7. First the sound waves 7 output from the speaker 6L and the speaker 6R are received by the microphone 8, and are output as the received acoustic signal 9 (S20) (receiving step). When the received acoustic signal 9 is output, the received acoustic signal 9 is converted into a digital signal by the A/D conversion unit 101 (S21).

When the received acoustic signal 9 is converted into a digital signal, the received acoustic signal 9 is divided in frame units by the frame synchronization unit 102 (S22). The guard time signal included in the received acoustic signal divided in frame units is removed by the guard time removal unit 103, and a signal frame is extracted (S23).

When the signal frame is extracted, a signal frame signal is demodulated by the demodulation unit 104 based on OFDM, and the parallel received bits r₁, r₂, r₃ and r₄ are extracted (S24). When the parallel received bits r₁, r₂, r₃ and r₄ are extracted, the parallel received bits r₁, r₂, r₃ and r₄ are decoded by the SFBC decoding unit 106 based on SFBC decoding, using the transfer functions h_{L12}, h_{L34}, h_{R12} and h_{R34}, and the parallel transmission bits T₁, T₂, T₃ and T₄ are determined (S25) (demodulation step).

When the parallel transmission bits T₁, T₂, T₃ and T₄ are determined, the parallel transmission bits T₁, T₂, T₃ and T₄ are converted into a signal bit stream by the P/S conversion unit 107, and are output as the receive transmission signal 11 (S26). When the receive transmission signal 11 is output, an error of the receive transmission signal 11 is corrected by the error correction decoding device 12 (S27). In this way, the received sound wave 7 is decoded.

As described above, according to the present embodiment, the SFBC encoding unit 42A of the modulation device 4A encodes the parallel transmission bits based on the spatial frequency encoding, and allocates the parallel transmission bits (s₁, s₂, s₃, s₄) and (s₂*, −s₁*, s₄*, −s₃*) to the speaker 6L and the speaker 6R. Then the speaker 6L and the speaker 6R output the transmission acoustic signal 5L and the transmission acoustic signal 5R, which include the allocated parallel transmission bits (s₁, s₂, s₃, s₄) and (s₂*, −s₁*, s₄*, −s₃*) respectively, as the sound waves 7. The SFBC decoding unit 106 of the demodulation device 10A decodes the parallel received bits r₁, r₂, r₃ and r₄ based on the spatial frequency decoding by using the transfer functions h_{L12}, h_{L34}, h_{R12} and h_{R34} of the respective sound wave from the speaker 6L and the speaker 6R to the microphone. Therefore even if frequency-selected fading is generated, the parallel received bits r₁, r₂, r₃ and r₄ can be decoded by using the above transfer function while suppressing the occurrence of reception errors.

The present invention is not limited to this embodiment, and various modifications are possible. In the above embodiment, the SFBC encoding unit 42A performs the spatial frequency encoding, and may perform time-space encoding. In the case of time-space encoding, a plurality of speakers and a plurality of time blocks are encoded as one block.

Also in the above embodiment, the sound wave 7 is received by, for example, one microphone 8, but may be received by a plurality of microphones.

### SECOND EMBODIMENT

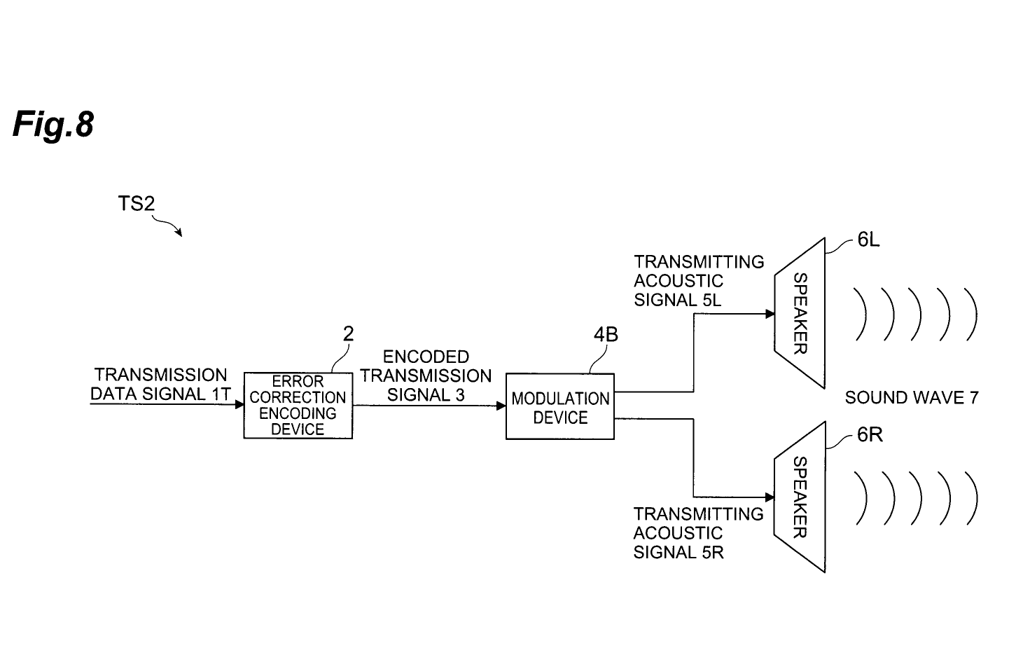

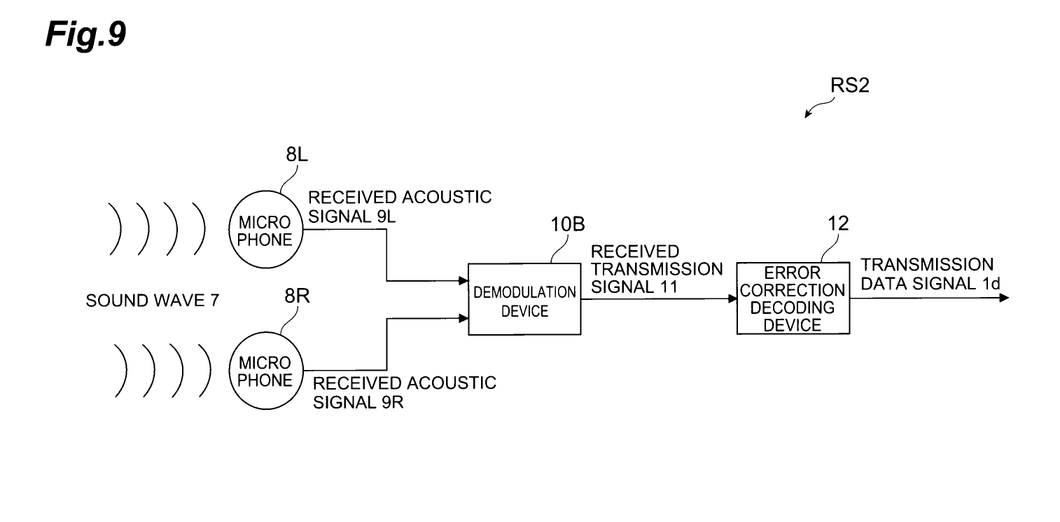

FIG. 8 is a block diagram depicting an acoustic signal sending system included in an acoustic signal transmission system according to a second embodiment. FIG. 9 is a diagram depicting an acoustic signal receiving system included in the acoustic signal transmission system according to the second embodiment. The acoustic signal transmission system according to the present embodiment includes the acoustic signal sending system TS2 and the acoustic signal receiving system RS2.

The acoustic signal sending system TS2 according to the present embodiment has a modulation device 4B, instead of the modulation device 4A included in the acoustic signal sending system TS1 according to the first embodiment.

The acoustic signal receiving system RS2 according to the present embodiment has a plurality of microphones (two microphones in the case of the present embodiment) 8L, 8R, instead of one microphone 8 included in the acoustic signal receiving system RS1 according to the first embodiment. The microphone 8L receives the sound wave 7, and outputs the received acoustic signal 9L, and the microphone 8R receives the sound wave 7, and outputs the received acoustic signal 9R. The acoustic signal receiving system RS2 also includes a demodulation devices 10B, instead of the demodulation unit 10A which is included in the acoustic signal receiving system RS1 according to the first embodiment. The demodulation device 10A inputs the received acoustic signal 9L and the received acoustic signal 9R, which are output from the microphone 8L and the microphone 8R respectively.

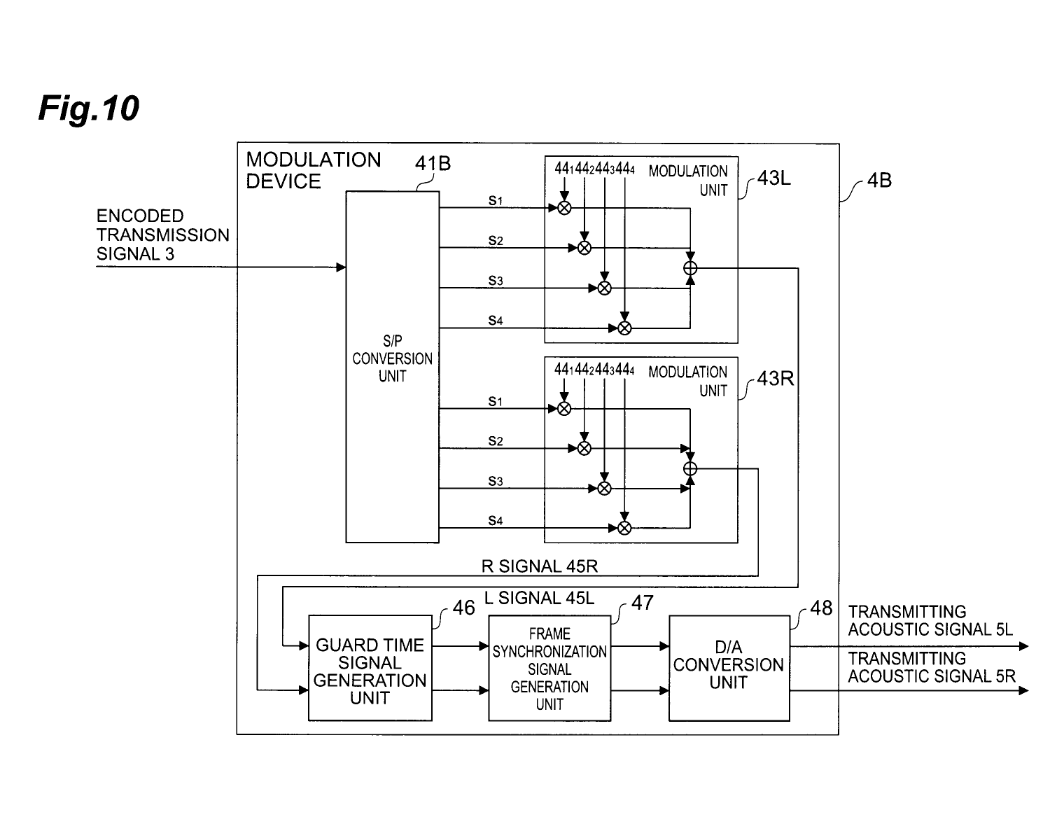

The modulation device 4B and the demodulation device 10B will now be described in detail. FIG. 10 is a diagram depicting a configuration of the modulation device according to the second embodiment. The modulation device 4B includes an S/P conversion unit (allocation means) 41B, a modulation unit (modulation means) 43L, a modulation unit (modulation means) 43R, a guard time signal generation unit 46, a frame synchronization signal generation unit 47 and a D/A conversion unit 48. The guard time signal generation unit 46, the frame synchronization signal generation unit 47 and the D/A conversion unit 48 have functions similar to each corresponding composing element of the above mentioned modulation device 4B according to the first embodiment.

The S/P conversion unit 41B converts an encoded transmission signal 3 which is input, from a single bit stream into a parallel bit stream. The S/P conversion unit 41B divides parallel transmission bits s₁, s₂, s₃, s₄, s₅, s₆, s₇ and s₈ of the parallel bit stream into two sets of parallel transmission bits (s₁, s₂, s₃, s₄) and (s₅, s₆, s₇, s₈). In other words, the S/P conversion unit 41B allocates the parallel transmission bits s₁, s₂, s₃ and s₄ to the speaker 6L, and allocates the parallel transmission bits s₅, s₆, s₇ and s₈ to the speaker 6R.

The S/P conversion unit 41B also allocates the parallel transmission bit s₁ to the first sub-carrier 44₁ output from the speaker 6L, allocates the parallel transmission bit s₂ to the second sub-carrier 44₂ output from the speaker 6L, allocates the parallel transmission bit s₃ to the third sub-carrier 44₃ output from the speaker 6L, and allocates the parallel transmission bit s₄ to the fourth sub-carrier 44₄ output from the speaker 6L. Further, the S/P conversion unit 41B outputs the parallel transmission bits s₁, s₂, s₃ and s₄ to the modulation unit 43L.

The S/P conversion unit 41B also allocates the parallel transmission bit s₅ to the first sub-carrier 44₁ output from the speaker 6R, allocates the parallel transmission bit s₆ to the second sub-carrier 44₂ output from the speaker 6R, allocates the parallel transmission bit s₇ to the third sub-carrier 44₃ output from the speaker 6R, and allocates the parallel transmission bit s₈ to the fourth sub-carrier 44₄ output from the speaker 6R. Then the S/P conversion unit 41B outputs the parallel transmission bits s₅, s₆, s₇ and s₈ to the modulation unit 43R.

As mentioned above, in the first to fourth sub-carriers 44₁ to 44₄, the frequency is lower in the sequence of the first sub-carrier 44₁, second sub-carrier 44₂, third sub-carrier 44₃ and fourth sub-carrier 44₄.

The modulation unit 43L modulates the first to fourth sub-carriers 44₁ to 44₄ with the corresponding parallel transmission bits s₁, s₂, s₃ and s₄ respectively based on OFDM. The modulation unit 43L outputs a signal generated by the modulation, to the guard time signal generation unit 46 as an L signal 45L. The modulation unit 43R modulates the first to fourth sub-carriers 44₁ to 44₄ with the corresponding parallel transmission bits s₅, s₆, s₇ and s₈ respectively based on OFDM. The modulation unit 43R outputs a signal generated by the modulation, to the guard time signal generation unit 46 as an R signal 45R.

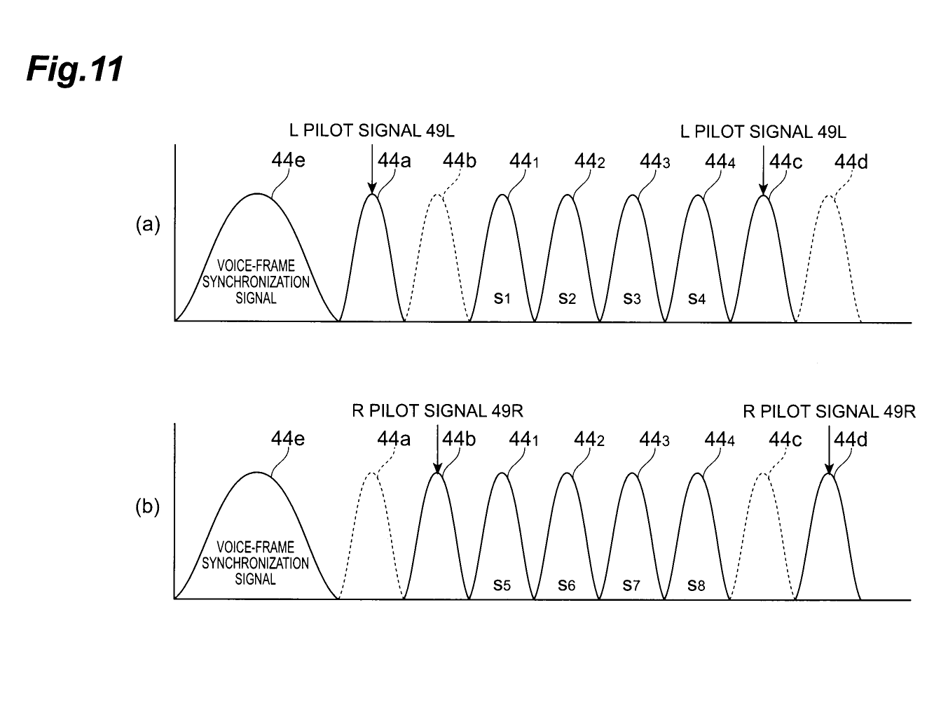

FIG. 11 are diagrams depicting the transmission acoustic signal according to the second embodiment. (a) of FIG. 11 is a diagram depicting the transmission acoustic signal 5L, and (b) of FIG. 11 is a diagram depicting the transmission acoustic signal 5R.

As (a) of FIG. 11 shows, the parallel transmission bit s₁ is allocated to the first sub-carrier 44₁, the parallel transmission bit s₂ is allocated to the second sub-carrier 44₂, the parallel transmission bit s₃ is allocated to the third sub-carrier 44₃, and the parallel transmission bit s₄ is allocated to the fourth sub-carrier 44₄ of the transmission acoustic signal 5L.

In the transmission acoustic signal 5L, an L pilot signal for 49L, which indicates that this signal is the transmission acoustic signal 5L, is allocated to sub-carriers 44a and 44c having a frequency different from the first to fourth sub-carriers 44₁ to 44₄. In the transmission acoustic signal 5L, sub-carriers 44b and 44d having a frequency different from the first to fourth sub-carriers 44₁ to 44₄ and sub-carriers 44a and 44c, are not used. In the transmission acoustic signal 5L, voice and a frame synchronization signal are disposed in a frequency band which is different from the first to fourth sub-carriers 44₁ to 44₄ and 44a to 44d.

As (b) of FIG. 11 shows, the parallel transmission bit s₅ is allocated to the first sub-carrier 44₁, the parallel transmission bit s₆ is allocated to the second sub-carrier 44₂, the parallel transmission bit s₇ is allocated to the third sub-carrier 44₃, and the parallel transmission bit s₈ is allocated to the fourth sub-carrier 44₄ of the transmission acoustic signal 5R.

In the transmission acoustic signal 5R, an R pilot signal for 49R, which indicates that this signal is the transmission acoustic signal 5R, is allocated to the sub-carriers 44b and 44d. In the transmission acoustic signal 5L, the sub-carriers 44a and 44c are not used. In the transmission acoustic signal 5R, voice and a frame synchronization signal are disposed in a frequency band which is different from the first to fourth sub-carriers 44₁ to 44₄ and 44a to 44d.

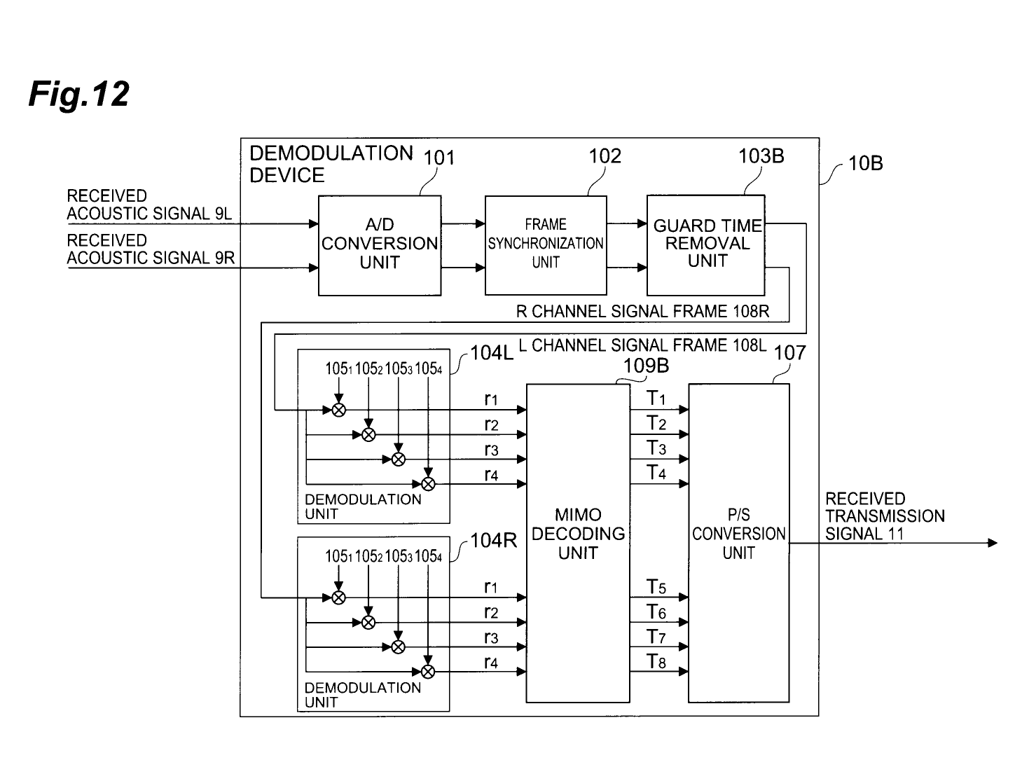

FIG. 12 is a diagram depicting a configuration of the demodulation device according to the second embodiment. The demodulation device 10B includes an A/D conversion unit 101, a frame synchronization unit 102, a guard time removal unit 103, a demodulation unit (demodulation means) 104L, a demodulation unit (demodulation means) 104R, an MIMO decoding unit (decoding means) 109 and a P/S conversion unit 107.

The A/D conversion unit 101 samples a received acoustic signal 9L and a received acoustic signal 9R, and converts both into digital signals respectively. The A/D conversion unit 101 outputs the received acoustic signal 9L and the received acoustic signal 9R, converted into digital signal, to the frame synchronization unit 102 respectively.

The frame synchronization unit 102 divides the received acoustic signal 9L and the received acoustic signal 9R, converted into digital signals, in frame units respectively so as to generate frame signals. The frame synchronization unit 102 outputs the generated frame signal of the received acoustic signal 9L and the generated frame signal of the received acoustic signal 9R to the guard signal removal unit 103B.

The guard time removal unit 103B removes a guard time signal from the signal frame of the received acoustic signal 9L, so as to extract the L channel signal frame 108L. The guard time removal unit 103B also removes a guard time signal from the signal frame of the received acoustic signal 9R, so as to extract the R channel signal frame 108R. The guard time removal unit 103B outputs the extracted L channel signal frame 108L to the demodulation unit 104L, and outputs the extracted R channel signal frame 108R to the demodulation unit 104R.

The demodulation unit 104L demodulates the L channel signal frame 108L by the first to fourth sub-carriers 105₁ to 105₄ based on OFDM, and extracts the parallel received bits r₁, r₂, r₃ and r₄. In the first to fourth sub-carriers 105₁ to 105₄, the frequency is lower in the sequence of the first sub-carrier 105₁, second sub-carrier 105₂, third sub-carrier 105₃, and fourth sub-carrier 105₄. The demodulation unit 104L extracts the parallel received bit r₁ by the first sub-carrier 105₁, extracts the parallel received bit r₂ by the second sub-carrier 105₂, extracts the parallel received bit r₃ by the third sub-carrier 105₃, and extracts the parallel received bit r₄ by the fourth sub-carrier 105₄.

The demodulation unit 104L also demodulates the sub-carrier of the pilot signal included in the L channel signal frame 108L based on OFDM, and extracts an L pilot signal for the R pilot signal. Thereby, it can be identified whether the parallel received bits r₁, r₂, r₃ or r₄ of each L channel signal frame 108L is a signal output from the speaker 6L or a signal output from the speaker 6R. The demodulation unit 104L outputs the parallel received bits r₁, r₂, r₃ and r₄ extracted from the L channel signal frame including the L pilot signal, and the parallel received bits r₁, r₂, r₃ and r₄ extracted from the L channel signal frame 108L including the R pilot signal, to the MIMO decoding unit 109B such that identification is possible.

The demodulation unit 104R demodulates the R channel signal frame 108R by the first to fourth sub-carriers 105₁ to 105₄ based on OFDM, and extracts the parallel received bits r₅, r₆, r₇ and r₈. The demodulation unit 104R extracts the parallel received bit r₅ by the first sub-carrier 105₁, extracts the parallel received bit r₆ by the second sub-carrier 105₂, extracts the parallel received bit r₇ by the third sub-carrier 105₃, and extracts the parallel received bit r₈ by the fourth sub-carrier 105₄.

The modulation unit 104R also demodulates the sub-carrier of the pilot signal included in the R channel signal frame 108R based on OFDM, and extracts the L pilot signal or the R pilot signal. Thereby it can be identified whether the parallel received bits r₅, r₆, r₇ or r₈ of each R channel signal frame 108R is a signal output from the speaker 6L or a signal output from the speaker 6R. The demodulation unit 104R outputs the parallel received bits r₅, r₆, r₇ and r₈ extracted from the R channel signal frame 108R including the R pilot signal, and the parallel received bits r₅, r₆, r₇ and r₈ extracted from the R channel signal frame 108R including the R pilot signal, to the MIMO decoding unit 109B such that identification is possible.

The MIMO decoding unit 109B decodes the parallel received bits (r₁, r₂, r₃, r₄) (r₅, r₆, r₇, r₈) based on MIMO (Multiple Input Multiple Output) using a transfer function of the each sound wave from each of the speakers, 6L and 6R, to each of the microphones, 8L and 8R, and extracts the parallel transmission bits (T₁, T₂, T₃, T₄, T₅, T₆, T₇, T₈).

For example, assume that an ideal transfer function from the speaker 6L to the microphone 8L is h₁₁, an ideal transfer function from the speaker 6R to the microphone 8L is h₂₁, an ideal transfer function from the speaker 6L to the microphone 8R is h₁₂, and an ideal transfer function from the speaker 6R to the microphone 8R is h₂₂. Then the relationship of the parallel transmission bit s₁ included in the L signal 45L and the parallel transmission bit s₅ included in the R signal for 45L, corresponding to the first sub-carrier 44₁, and the parallel received bit r₁ included in the L channel signal frame 108L and the parallel received bit r₅ included in the R channel signal frame 108R, corresponding to the first sub-carrier 105₁ is given by the following Formula (2).

### [Formula 2]

$$( \begin{matrix}{r}_{1} \\ {r}_{5}\end{matrix} ) = ( \begin{matrix}{h}_{11} & {h}_{21} \\ {h}_{12} & {h}_{22}\end{matrix} ) ( \begin{matrix}{s}_{1} \\ {s}_{5}\end{matrix} ) \qquad ( 2 )$$

Therefore the parallel transmission bits s₁ and s₅ can be calculated by the following Formula (3).

### [Formula 3]

$$( \begin{matrix}{s}_{1} \\ {s}_{5}\end{matrix} ) = {( \begin{matrix}{h}_{11} & {h}_{21} \\ {h}_{12} & {h}_{22}\end{matrix} )}^{- 1} ( \begin{matrix}{r}_{1} \\ {r}_{5}\end{matrix} ) \qquad ( 3 )$$

The MIMO decoding unit 109B calculates each transfer function as follows. The MIMO decoding unit 109B calculates the transfer function h_{LL} from the speaker 6L to the microphone 8L using a sub-carrier which is included in the L channel signal frame 108L and to which the L pilot signal for 49L is allocated. The MIMO decoding unit 109B calculates the transfer function h_{RL} from the speaker 6R to the microphone 8L using a sub-carrier which is included in the L channel signal frame 108L and to which the R pilot signal for 49R is allocated.

The MIMO decoding unit 109B calculates a transfer function h_{LR} from the speaker 6L to the microphones 8R using a sub-carrier which is included in the R channel signal frame 108R and to which the L pilot signal for 49L is allocated. The MIMO decoding unit 109B calculates a transfer function h_{RR} from the speaker 6R to the microphone 8R using sub-carriers 44b and 44d which are included in the R channel signal frame 108R and to which the R pilot signal for 49R is allocated.

The MIMO decoding unit 109B calculates the parallel transmission bits T₁ and T₅ by the following Formula (4), using the calculated transfer functions h_{LL}, h_{RL}, h_{LR} and h_{RR} and the parallel received bits r₁ and r₅ corresponding to the first sub-carrier 105₁.

### [Formula 4]

$$( \begin{matrix}{T}_{1} \\ {T}_{5}\end{matrix} ) = {( \begin{matrix}{h}_{LL} & {h}_{RL} \\ {h}_{LR} & {h}_{RR}\end{matrix} )}^{- 1} ( \begin{matrix}{r}_{1} \\ {r}_{5}\end{matrix} ) \qquad ( 4 )$$

In the same manner, the MIMO decoding unit 109B calculates the parallel transmission bits T₂ and T₆ using the calculated transfer functions h_{LL}, h_{RL}, h_{LR} and h_{RR} and the parallel received bits r₂ and r₆ corresponding to the second sub-carrier 105₂. In the same manner, the MIMO decoding unit 109B calculates the parallel transmission bits T₃ and T₇ using the calculated transfer functions h_{LL}, h_{RL}, h_{LR} and h_{RR} and the parallel received bits r₃ and r₇ corresponding to the third sub-carrier 105₃. In the same manner, the MIMO decoding unit 109B calculates the parallel transfer bits T₄ and T₈ using the calculated transfer functions h_{LL}, h_{RL}, h_{LR} and h_{RR} and the parallel received bits r₄ and r₈ corresponding to the fourth sub-carrier 105₄. The MIMO decoding unit 109B outputs the calculated parallel transmission bits (T₁, T₂, T₃, T₄, T₅, T₆, T₇, T₈) to the P/S conversion unit 107.

The P/S conversion unit 107 converts the parallel transmission bits (T₁, T₂, T₃, T₄, T₅, T₆, T₇, T₈) into a single bit stream, and outputs it as a receive transmission signal 11.

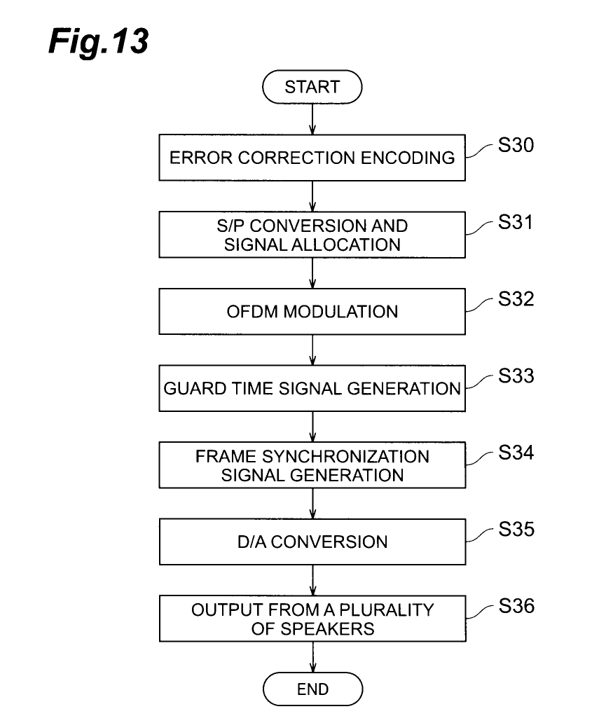

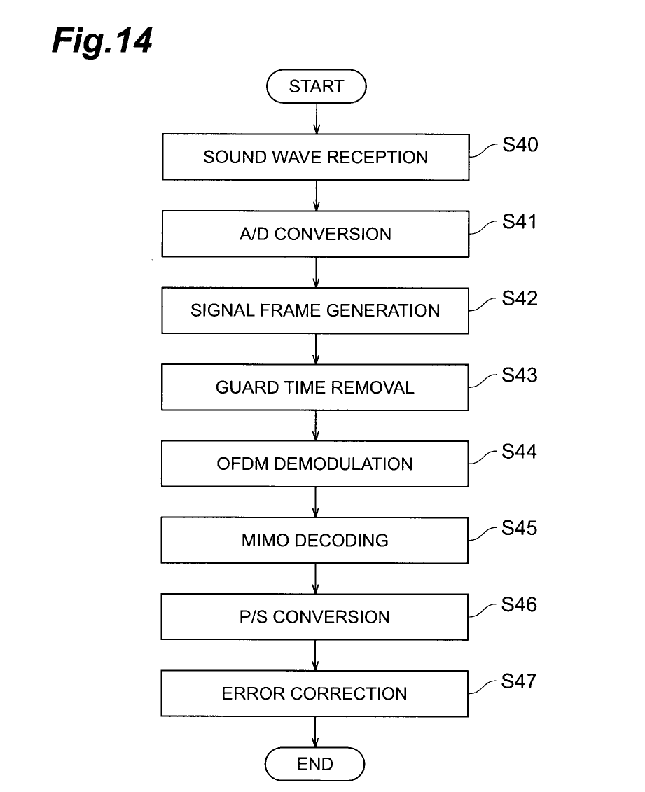

Now the operation of the acoustic signal sending system TS2 including the demodulation device 4B and the operation of the acoustic signal receiving system RS2 including the modulation device 10B will be described, and the acoustic signal transmission method according to the present embodiment will be described with reference to FIG. 13 and FIG. 14. FIG. 13 is a flow chart depicting the operation of the acoustic signal sending system according to the second embodiment. FIG. 14 is a flow chart depicting the operation of the acoustic signal receiving system according to the second embodiment.

First the operation of the acoustic signal sending system TS2 will be described with reference to FIG. 13. The transmission data signal 1 is encoded by the error correction encoding device 2 using error correction codes, and the encoded transmission signal 3 is generated (S30).

The generated encoded transmission signal 3 is converted into a parallel bit stream by the S/P conversion unit 41B of the modulation device 4B, and the parallel transmission bits s₁, s₂, s₃ and s₄ are allocated to the speaker 6L, and the parallel transmission bits s₅, s₆, s₇ and s₈ are allocated to the speaker 6R (S31). For each of the parallel transmission bits (s₁, s₂, s₃, s₄) and (s₅, s₆, s₇, s₈) of the parallel bit stream, the first to fourth sub-carriers 44₁ to 44₄ are modulated by the modulation units 43L and 43R respectively based on OFDM, and the L signal 45L and the R signal 45R are generated respectively (S32). In other words, in step S31 and step S32, the transmission signals are allocated to a plurality of transmission paths (modulation step).

When the L signal 45L and the R signal 45R are generated, then guard time signal is generated by the guard time signal generation unit 46, and is added to the L signal 45L and the R signal 45R respectively (S33). When the guard time signal is added, the frame synchronization signal is generated by the frame synchronization signal generation unit 47, and is added to the L signal 45L and the R signal 45R respectively (S34). The L signal 45L and the R signal 45R, to which the frame synchronization signal is added, are converted into analog signals respectively by the D/A conversion unit 48, and the transmission acoustic signal 5L and the transmission acoustic signal 5R are generated (S35).

When the transmission acoustic signal 5L and the transmission acoustic signal 5R are generated, the transmission acoustic signal 5L and the transmission acoustic signal 5R are output from the speaker 6L and the speaker 6R respectively as sound waves 7 (S36) (output step). In this way, the sound wave 7 carrying the transmission data signal 1 is output from the two speakers 6L and 6R.

Now the operation of the acoustic signal receiving system RS2 will be described with reference to FIG. 14. First the sound waves 7 output from the speaker 6L and the speaker 6R are received by the microphone 8L and the microphone 8R, and are output as the received acoustic signals 9R and 9L respectively (S40) (reception step). When the received acoustic signals 9R and 9L are output, the received acoustic signals 9R and 9L are converted into digital signals by the A/D conversion unit 101 respectively (S41).

When the received acoustic signals 9R and 9L are converted into digital signals, the received acoustic signals 9R and 9L are divided in frame units respectively by the frame synchronization unit 102 (S42). The guard time signals, which are included in the divided frame signals respectively, are removed by the guard time removal unit 103, and an L channel signal frame 108L and an R channel signal frame 108R are extracted respectively (S43).

When the L channel signal frame 108L and the R channel signal frame 108R are extracted, the L channel signal frame 108L and the R channel signal frame 108R are demodulated by the demodulation unit 104L and the demodulation unit R respectively based on OFDM and the parallel received bits (r₁, r₂, r₃, r₄) (r₅, r₆, r₇, r₈) are extracted respectively (S44). When the parallel received bits (r₁, r₂, r₃, r₄) (r₅, r₆, r₇, r₈) are extracted, the parallel received bits (r₁, r₂, r₃, r₄) and (r₅, r₆, r₇, r₈) are decoded by the MIMO decoding unit 109 based on MIMO, using the transfer functions h_{LL}, h_{LR}, h_{RL} and h_{RR}, and the parallel transfer bits (T₁, T₂, T₃, T₄, T₅, T₆, T₇, T₈) are determined (S45). In other words, in step S44 and step S45, the received acoustic signal is decoded using each transfer function h_{LL}, h_{LR}, h_{RL} and h_{RR} (demodulation step).

When the parallel transmission bits (T₁, T₂, T₃, T₄, T₅, T₆, T₇, T₈) are determined, the parallel transmission bits (T₁, T₂, T₃, T₄, T₅, T₆, T₇, T₈) are converted into a single bit stream by the P/S conversion unit 107, and is output as the receive transmission signal 11 (S46). When the receive transmission signal 11 is output, an error of the receive transmission signal 11 is corrected by the error correction decoding device 12 (S47). In this way, the receive sound wave 7 is decoded.

As described above according to the present embodiment, The S/P conversion unit 41B of the modulation device 4B allocates the parallel transmission bits (s₁, s₂, s₃, s₄) and (s₅, s₆, s₇, s₈) to the speaker 6L and the speaker 6R. Further, the speaker 6L and the speaker 6R output the allocated transmission acoustic signal 5L and the transmission acoustic signal 5R respectively as sound waves. Then the microphone 8L and the microphone 8R receive the sound waves. Thereafter, the demodulation device 10B decodes the sound waves using the transfer functions h_{LL}, h_{LR}, h_{RL} and h_{RR} of the respective sound wave from each speaker 6L and 6R to each microphone 8L and 8R. Therefore even if frequency-selected fading is generated, the parallel received bits (r₁, r₂, r₃, r₄) and (r₅, r₆, r₇, r₈) can be decoded using the above transfer functions h_{LL}, h_{LR}, h_{RL} and h_{RR}, with suppressing the occurrence of reception errors. Also the sound waves are received by a plurality of microphones 8L and 8R, so the occurrence of reception errors can be suppressed more efficiently.

### THIRD EMBODIMENT

An acoustic signal transmission system according to the present embodiment includes an acoustic signal sending system and an acoustic signal receiving system. The acoustic signal sending system according to the present embodiment has a modulation device 4C, instead of the modulation device 4B included in the acoustic signal sending system TS2 according to the second embodiment. The acoustic signal receiving system according to the present embodiment has a demodulation device 10C instead of the demodulation device 10B included in the acoustic signal receiving system RS2 according to the second embodiment.

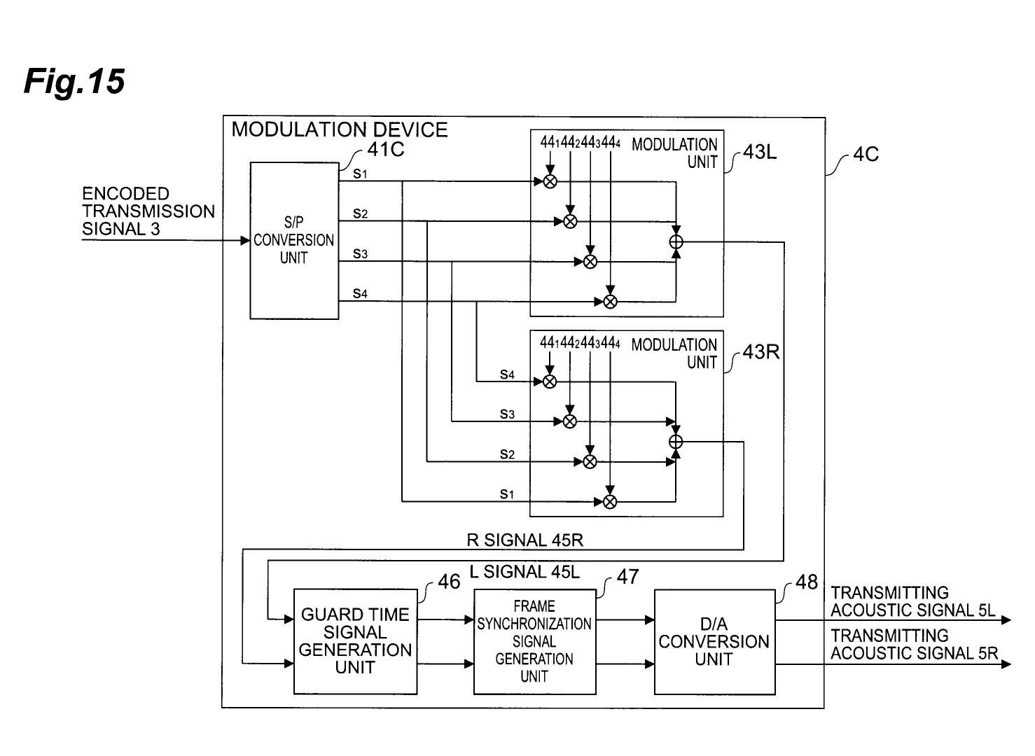

The modulation device 4C and the demodulation device 10C will now be described in detail. FIG. 15 is a diagram depicting a configuration of the modulation device according to the third embodiment. The modulation device 4C includes an S/P conversion unit (allocation means) 41C, a modulation unit (modulation means) 43L, a modulation unit (modulation means) 43R, a guard time signal generation unit 46, a frame synchronization signal generation unit 47 and a D/A conversion unit 48. The guard time signal generation unit 46, the frame synchronization signal generation unit 47, and the D/A conversion unit 48 have functions similar to the corresponding composing elements in the modulation device 4C according to the second embodiment.

The S/P conversion unit 41C converts an encoded transmission signal 3 which is input, from a single bit stream into a parallel bit stream. The S/P conversion unit 41B divides parallel transmission bits s₁, s₂, s₃ and s₄ of the parallel bits stream into a speaker 6L and a speaker 6R, which are two transmission paths respectively.

The S/P conversion unit 41C further allocates each of the parallel transmission bits s₁, s₂, s₃ and s₄ allocated to the speaker 6L to the first to fourth sub-carriers 44₁ to 44₄ which are output from the speaker 6L. In the first to fourth sub-carriers 44₁ to 44₄, the frequency is lower in the sequence of the first sub-carrier 44₁, second sub-carrier 44₂, third sub-carrier 44₃ and fourth sub-carrier 44₄. The S/P conversion unit 41C allocates the parallel transmission bit s₁ to the first sub-carrier 44₁, allocates the parallel transmission bit s₂ to the second sub-carrier 44₂, allocates the parallel transmission bit s₃ to the first sub-carrier 44₃, and allocates the parallel transmission bit s₄ to the fourth sub-carrier 44₄. The S/P conversion unit 41C outputs the parallel transmission bits s₁, s₂, s₃ and s₄ allocated in this way to the modulation unit 43L.

The S/P conversion unit 41C also allocates each parallel transmission bit s₁, s₂, s₃ and s₄ allocated to the speaker 6R to the first to fourth sub-carriers 44₁ to 44₄, which are output from the speaker 6R. The S/P conversion unit 41C allocates the parallel transmission bit s₁ to the fourth sub-carrier 44₄, allocates the parallel transmission bit s₂ to the third sub-carrier 44₃, allocates the parallel transmission bit s₃ to the second sub-carrier 44₂, and allocates the parallel transmission bit s₄ to the first sub-carrier 44₁. The S/P conversion unit 41C outputs the parallel transmission bits s₁, s₂, s₃ and s₄ allocated like this to the modulation unit 43R.

The modulation unit 43L modulates the first sub-carrier 44₁ with the parallel transmission bit s₁ based on OFDM, modulates the second sub-carrier 44₂ with the parallel transmission bit s₂ based on OFDM, modulates the third sub-carrier 44₃ with the parallel transmission bit s₃ based on OFDM, and modulates the fourth sub-carrier 44₄ with the parallel transmission bit s₄ based on OFDM. Then the modulation unit 43L outputs the modulated signal to the guard time signal generation unit 46 as an L signal 45L.

The modulation unit 43R modulates the fourth sub-carrier 44₄ with the parallel transmission bit s₁ based on OFDM, modulates the third sub-carrier 44₃ with the parallel transmission bit s₂ based on OFDM, modulates the second sub-carrier 44₂ with the parallel transmission bit s₃ based on OFDM, and modulates the first sub-carrier 44₁ with the parallel transmission bit s₄ based on OFDM. Then the modulation unit 43R outputs the modulated signal to the guard time signal generation unit 46 as an R signal 45R.

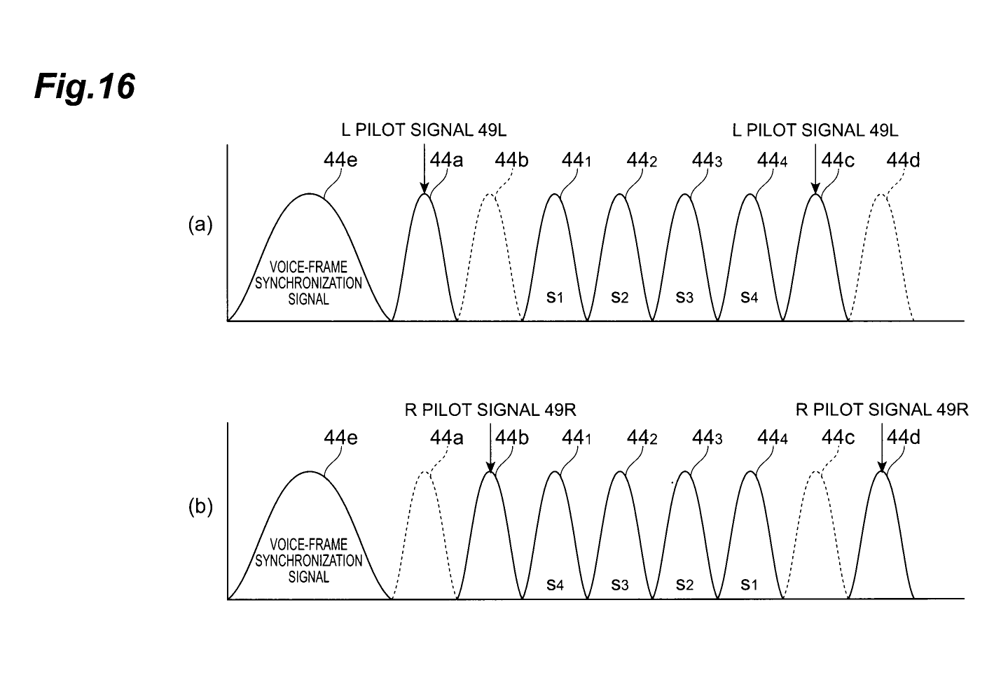

FIG. 16 are diagrams depicting the transmission acoustic signal according to the third embodiment. (a) of FIG. 16 is a diagram depicting the transmission acoustic signal 5L. (b) of FIG. 16 is a diagram depicting the transmission acoustic signal 5R.

The parallel transmission bit s₁ is allocated to the first sub-carrier 44₁ of the transmission acoustic signal 5L, the parallel transmission bit s₂ is allocated to the second sub-carrier 44₂, the parallel transmission bit s₃ is allocated to the third sub-carrier 44₃, and the parallel transmission bit s₄ is allocated to the fourth sub-carrier 44₄. The parallel transmission unit s₄ is allocated to the first sub-carrier 44₁, the parallel transmission bit s₃ is allocated to the second sub-carrier 44₂, the parallel transmission bit s₂ is allocated to the third sub-carrier 44₃, and the parallel transmission bit s₁ is allocated to the fourth sub-carrier 44₄ of the transmission acoustic signal 5R.

In other words, the S/P conversion unit 41C allocates the parallel transmission bit s₁ to the first sub-carrier 44₁ of which frequency is lowest among the first to fourth sub-carriers 44₁ to 44₄ which are output by the speaker 6L. The S/P conversion unit 41C allocates the parallel transmission bit s₁ to the fourth sub-carrier 44₄, of which frequency is highest among the first to fourth sub-carriers 44₁ to 44₄ which are output by the speaker 6R.

The S/P conversion unit 41C allocates the parallel transmission bit s₂ to the second sub-carrier 44₂ of which frequency is second lowest among the first to fourth sub-carriers 44₁ to 44₄ which are output by the speaker 6L. The S/P conversion unit 41C allocates the parallel transmission bit s₂ to the third sub-carrier 44₃ of which frequency is second highest among the first to fourth sub-carriers 44₁ to 44₄ which are output by the speaker 6R.

The S/P conversion unit 41C allocates the parallel transmission bit s₃ to the third sub-carrier 44₃ of which frequency is second highest among the first to fourth sub-carriers 44₁ to 44₄ which are output by the speaker 6L. The S/P conversion unit 41C allocates the parallel transmission bit s₃ to the second sub-carrier 44₂ of which frequency is second lowest among the first to fourth sub-carriers 44₁ to 44₄ which are output by the speaker 6R.

The S/P conversion unit 41C allocates the parallel transmission bit s₄ to the fourth sub-carrier 44₄ of which frequency is the highest among the first to fourth sub-carriers 44₁ to 44₄ which are output by the speaker 6L. The S/P conversion unit 41C allocates the parallel transmission bit s₄ to the first sub-carrier 44₁ of which frequency is the lowest among the first to fourth sub-carriers 44₁ to 44₄ which are output by the speaker 6R.

Just like the first and second embodiments, in the transmission acoustic signal 5L, an L pilot signal, which indicates that this signal is the transmission acoustic signal 5L, is allocated to the sub-carriers 44a and 44c, which are different from the first to fourth sub-carriers 44₁ to 44₄. Also just like the first and second embodiments, in the transmission acoustic signal 5R, an R pilot signal, which indicates that this signal is the transmission acoustic signal 5R, is allocated to the sub-carriers 44b and 44d, which are different from the first to fourth sub-carriers 44₁ to 44₄.

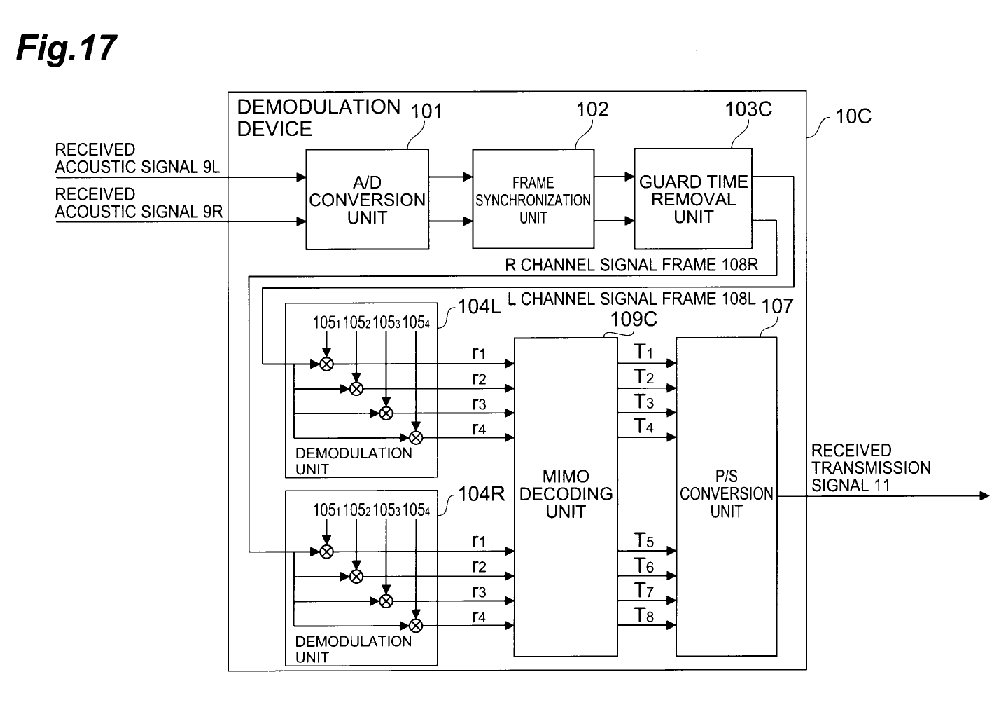

FIG. 17 is a diagram depicting a configuration of the demodulation device according to the third embodiment. The demodulation device 10C includes an A/D conversion unit 101, a frame synchronization unit 102, a guard time removal unit 103, a demodulation unit (demodulation means) 104L, a demodulation unit (demodulation means) 104R, an MIMO decoding unit (decoding means) 109C and a P/S conversion unit 107. The A/D conversion unit 101, the frame synchronization unit 102 and the guard time removal unit 103 have functions similar to the corresponding composing elements of the demodulation device 10C according to the second embodiment.

The demodulation unit 104L demodulates the L channel signal frame 108L with the first sub-carrier 105₁ based on OFDM, and extracts the parallel received bit r₁. The demodulation unit 104L demodulates the L channel signal frame 108L with the second sub-carrier 105₂ based on OFDM, and extracts the parallel received bit r₂. The demodulation unit 104L demodulates the L channel signal frame 108L with the third sub-carrier 105₃ based on OFDM, and extracts the parallel received bit r₃. And the demodulation unit 104L demodulates the L channel signal frame 108L with the first sub-carrier 105₄ based on OFDM, and extracts the parallel received bit r₄.

The demodulation unit 104L demodulates the sub-carrier of the L channel signal frame 108L based on OFDM, and extracts an L pilot signal or an R pilot signal. Thereby it can be identified whether the parallel received bit r₁, r₂, r₃ and r₄ of each L channel signal frame 108L is a signal which was output from the speaker 6L or a signal which was output from the speaker 6R. The demodulation unit 104 outputs the parallel received bits r₁, r₂, r₃ and r₄, which are extracted from the L channel signal frame 108L that includes the L pilot signal, and the parallel received bits r₁, r₂, r₃ and r₄, which are extracted from the R signal frame 108R that includes the R pilot signal, to the MIMO decoding unit 109C respectively.

The modulation unit 104R demodulates the R channel signal frame 108R with the first sub-carrier 105₁ based on OFDM, and extracts the parallel received bit r₅. The modulation unit 104R demodulates the R channel signal frame 108R with the second sub-carrier 105₂ based on OFDM, and extracts the parallel received bit r₆. The modulation unit 104R demodulates the R channel signal frame 108R with the third sub-carrier 105₃ based on OFDM, and extracts the parallel received bit r₇. And the modulation unit 104R demodulates the R channel signal frame 108R with the first sub-carrier 105₄ based on OFDM, and extracts the parallel received bit r₈.

The demodulation unit 104R also demodulates the sub-carrier of the R channel signal frame 108R based on OFDM, and extracts an L pilot signal or an R pilot signal. Thereby it can be identified whether the parallel received bit r₅, r₆, r₇ or r₈ of each R channel signal frame 108R is a signal output from the speaker 6L or a signal output from the speaker 6R. The demodulation unit 104 outputs the parallel received bits r₅, r₆, r₇ and r₈ extracted from the L channel signal frame 108L including the L pilot signal and the parallel received bits r₅, r₆, r₇ and r₈ extracted from the R channel signal frame 108R including the R pilot signal, to the MIMO decoding unit 109C respectively.

The MIMO decoding unit 109C decodes the parallel received bits (r₁, r₂, r₃, r₄) and (r₅, r₆, r₇, r₈) based on MIMO (Multiple Input Multiple Output) using a transfer function of the each sound wave from each of the speakers 6L and 6R and each of the microphones 8L and 8R respectively, and extracts the parallel transmission bits (T₁, T₂, T₃, T₄).

The MIMO decoding unit 109C calculates the transfer functions h_{LL}, h_{LR}, h_{RL} and h_{RR}, as mentioned above. The MIMO decoding unit 109C calculates the parallel transmission bits T₁ and T₄ by Formula (5) using the calculated transfer functions h_{LL}, h_{LR}, h_{RL} and h_{RR} and the parallel received bits r₁, r₄, r₅ and r₈. The parallel received bits r₁ and r₄ correspond to the first and fourth sub-carriers 105₁ and 105₄ of the L channel signal frame 108L, and the parallel received bits r₅ and r₈ correspond to the first and fourth sub-carriers 105₁ and 105₄ of the R channel signal frame 108R.

### [Formula 5]

$$( \begin{matrix}{T}_{1} \\ {T}_{4}\end{matrix} ) = {( \begin{matrix}{h}_{LL} & {h}_{RL} \\ {h}_{LR} & {h}_{RR}\end{matrix} )}^{- 1} ( \begin{matrix}{r}_{1} \\ {r}_{5}\end{matrix} ) + {( \begin{matrix}{h}_{LL} & {h}_{RL} \\ {h}_{LR} & {h}_{RR}\end{matrix} )}^{- 1} ( \begin{matrix}{r}_{8} \\ {r}_{4}\end{matrix} ) \qquad ( 5 )$$

In the same manner, the MIMO decoding unit 109C calculates the parallel transmission bits T₂ and T₃ using the transfer functions h_{LL}, h_{LR}, h_{RL} and h_{RR} and the parallel received bits r₂, r₃, r₆ and r₇. The parallel received bits r₂ and r₃ correspond to the second and third sub-carriers 105₂ and 105₃ of the L channel signal frame 108L, and the parallel received bits r₆ and r₇ correspond to the second and third sub-carriers 105₂ and 105₃ of the R channel signal frame 108R. The MIMO decoding unit 109C outputs the calculated parallel transmission bits (T₁, T₂, T₃, T₄) to the P/S conversion unit 107.

The P/S conversion unit 107 converts the parallel transmission bits (T₁, T₂, T₃, T₄) into a single bit stream, and outputs it as a receive transmission signal 11.

Directivity during propagation is sharper as the frequency of the sub-carrier becomes higher, and the directivity during propagation spreads wider as the frequency of the sub-carrier becomes lower. Therefore if the sub-carrier having a high frequency is output deviating from the front face of each speaker 6L and 6R when the transmission acoustic signal 5L and the transmission acoustic signal 5R are output from the speaker 6L and the speaker 6R respectively, the receive power by the microphones 8L and 8R of the sub-carrier with high frequency drops. As a result, reception errors occur due to the drop in receive power by the microphones 8L and 8R.

The S/P conversion unit 41C of the modulation device 4C of the present embodiment allocates the parallel transmission bits s₃ and s₄ that are allocated to the third and fourth sub-carriers 44₃ and 44₄ which are output from the speaker 6L and have sharp directivity and high frequency, and also allocates to the first and second sub-carriers 44₁ and 44₂ which are output from the speaker 6R and have wide directivity and low frequency. The S/P conversion unit 41C also allocates the parallel transmission bits s₁ and s₂, that are allocated to the third and fourth sub-carriers 44₃ and 44₄ which are output from the speaker 6R and have a sharp directivity and high frequency, and also allocates to the first and second sub-carriers 44₁ and 44₂ which are output from the speaker 6L and have a wide directivity and low frequency.

Hence even if the third and fourth sub-carriers 44₃ and 44₄ having a high frequency are output deviating from a front face of the speakers 6L and 6R and sound waves become weak, the first and second sub-carriers 44₁ and 44₂ having low frequency can be output as high sound waves, and the parallel transmission bits s₁, s₂, s₃ and s₄ can be transmitted with higher certainty, and the occurrence of reception errors can be suppressed. In other words, the parallel transmission bits s₁, s₂, s₃ and s₄ can be transmitted according to the directional characteristics, which differs depending on the frequency of the sub-carrier.

1. An acoustic signal transmission system for transmitting information via sound waves, comprising:
a modulation device that generates a plurality of transmission acoustic signals by encoding transmission signals based on a transmission diversity method and allocating the encoded transmission signals to a plurality of transmission paths;
a plurality of speakers that output said plurality of transmission acoustic signals as sound waves respectively based on said allocation;
a microphone that receives the sound waves which are output from said plurality of speakers, and outputs received acoustic signals; and
a demodulation device that decodes the received acoustic signals based on the transmission diversity method by using a transfer function of the each sound wave from each of said plurality of speakers to said microphone.

2. An acoustic signal transmission system for transmitting information via sound waves, comprising:
a modulation device that generates a plurality of transmission acoustic signals by allocating transmission signals to a plurality of transmission paths;
a plurality of speakers that output said plurality of transmission acoustic signals as sound waves respectively based on said allocation;
a plurality of microphones that receive the sound waves which are output from said plurality of speakers and output received acoustic signals respectively; and
a demodulation device that decodes said received acoustic signals by using a transfer function of the each sound wave from each of said plurality of speakers to each of said plurality of microphones.

3. The acoustic signal transmission system according to claim 2, characterized in that said modulation device comprises allocation means for allocating said transmission signals to frequency of each sub-carrier which is transmitted by each of said plurality of transmission paths respectively, based on directional characteristics of the sub-carrier.

4. A modulation device, comprising:
encoding means for generating a plurality of encoded transmission signals by encoding transmission signals based on spatial frequency encoding and allocating the encoded transmission signals to a plurality of transmission paths; and
modulation means for generating a plurality of transmission acoustic signals by modulating sub-carriers in an audible sound band based on OFDM by using said allocated encoded transmission signals respectively, and allocating the modulated sub-carriers to said plurality of transmission paths.

5. A modulation device, comprising:
allocation means for allocating transmission signals to a plurality of transmission paths; and
modulation means for generating a plurality of transmission acoustic signals by modulating sub-carriers in an audible sound band based on OFDM by using said transmission signals that are encoded, and allocating the modulated sub-carriers to said plurality of transmission paths.

6. The modulation device according to claim 5, characterized in that
said plurality of transmission paths include a first transmission path and a second transmission path, and
said allocation means allocates transmission signals to sub-carriers having a relatively low frequency out of sub-carriers that are output by said first transmission path, and allocates said allocated transmission signals to sub-carriers having a relatively high frequency out of sub-carriers that are output by said second transmission path.

7. A demodulation device, comprising:
demodulation means for generating encoded received signals by demodulating received acoustic signals, which are output from a plurality of speakers and received by a microphone, based on OFDM; and
decoding means for decoding said encoded received signals based on special frequency decoding, by using a transfer function of the each sound wave from each of said plurality of speakers to said microphone.

8. A demodulation device, comprising:
demodulation means for generating encoded received signals by respectively demodulating received acoustic signals, which are output from a plurality of speakers and received respectively by a plurality of microphones, based on OFDM; and
decoding means for decoding said encoded received signals by using a transfer function of the each sound wave from each of said plurality of speakers to each of said plurality of microphones.

9. An acoustic signal transmission method for transmitting information via sound waves, comprising:
a modulation step wherein a modulation device generates a plurality of transmission acoustic signals, by encoding transmission signals based on a transmission diversity method and allocating the encoded transmission signals to a plurality of transmission paths;
an output step wherein a plurality of speakers output said plurality of transmission acoustic signals as sound waves respectively based on said allocation;
a reception step wherein a microphone receives the sound waves which are output from said plurality of speakers and outputs received acoustic signals; and
a demodulation step wherein a demodulation device decodes the received acoustic signals based on the transmission diversity method by using a transfer function of the each sound wave from each of said plurality of speakers to said microphone.

10. An acoustic signal transmission method for transmitting information via sound waves, comprising:
a modulation step wherein a modulation device generates a plurality of transmission acoustic signals by allocating transmission signals to a plurality of transmission paths;
an output step wherein a plurality of speakers output said plurality of transmission acoustic signals as sound waves respectively based on said allocation;
a reception step wherein a plurality of microphones receive the sound waves which are output from said plurality of speakers, and output received acoustic signals respectively; and
a demodulation step wherein a demodulation device decodes said received acoustic signals by using a transfer function of the each sound wave from each of said plurality of speakers to each of said plurality of microphones.
